(19) United States
(12) Patent Application Publication
(10) Pub. No.: US 2025/0368905 A1
(43) Pub. Date: Dec. 4, 2025

(54) A PROCESS FOR PRODUCING LIQUID TRANSPORTATION FUEL COMPONENTS

(71) Applicant: Neste Oyj, Espoo (FI)

(72) Inventors: Kaisa LAMMINPÄÄ, Porvoo (FI); Ville SUNTIO, Porvoo (FI); Pekka AALTO, Porvoo (FI); Sami TOPPINEN, Porvoo (FI); Väinö SIPPOLA, Porvoo (FI); Yaseen KHAN, Porvoo (FI)

(73) Assignee: Neste Oyj, Espoo (FI)

(21) Appl. No.: 18/876,355

(22) PCT Filed: Jun. 30, 2023
(86) PCT No.: PCT/FI2023/050415

§ 371 Date: Dec. 18, 2024

(30) Foreign Application Priority Data
Jun. 30, 2022 (FI) 20225603
Jun. 30, 2022 (FI) 20225604
Jun. 30, 2022 (FI) 20225605
Jun. 30, 2022 (FI) 20225606
Jun. 30, 2022 (FI) 20225607
Jun. 30, 2022 (FI) 20225608
Jun. 30, 2022 (FI) 20225609
Dec. 2, 2022 (FI) 20226071

(51) Int. Cl. C10G 65/12

(52) U.S. Cl. CPC C10G 65/12; C10G 2300/1081; C10G 2300/201; C10G 2300/4006; C10G 2300/4012; C10G 2300/4018; C10G 2300/4081; C10G 2300/70; C10G 2400/08

(57) ABSTRACT

A process for producing at least one liquid transportation fuel component is provided. In the process, a paraffinic hydrocarbon feed is provided and subjected to hydroisomerisation to obtain a hydroisomerisation effluent; from which hydroisomerisation effluent a recycle stream is separated and subjected to hydrocracking to obtain a recycle effluent, the hydroisomerisation effluent and the recycle effluent being fed to fractionation, from which fractionation at least one liquid transportation fuel component is recovered.

### TECHNICAL FIELD

The present disclosure generally relates to a process for producing renewable fuel components. The disclosure relates particularly, though not exclusively, to a process for producing at least one or more liquid transportation fuel components, preferably at least an aviation fuel component.

### BACKGROUND

This section illustrates useful background information without admission of any technique described herein representative of the state of the art.

There is an ongoing need to reduce greenhouse gas emissions and/or carbon footprint in transportation, especially aviation. Accordingly, interest towards renewable aviation fuels and aviation fuel components is and has been growing.

Processes for producing aviation fuel components from renewable raw materials have been proposed. However, the yield of aviation fuel components (compared to other fuel components) has been relatively low in said processes. Also, there is a need to improve quality of renewable aviation fuel components. Particularly, there is an interest towards producing aviation fuel components that could be used in aviation fuels in elevated amounts, or when suitably additized even as such as an aviation fuel.

### SUMMARY

It is an aim to solve or alleviate at least some of the problems related to prior art. An aim is to improve quality of aviation fuel components obtainable from renewable sources. A further aim is to enable increasing the yield of an aviation fuel component. Another aim is to reduce formation of C1-C4 hydrocarbons, especially C1-C2 hydrocarbons, in a process for producing renewable liquid transportation fuel components. Yet further, an aim is to prolong hydroisomerisation catalyst lifetime in a process for producing renewable liquid transportation fuel components.

The appended claims define the scope of protection. Any examples and technical descriptions of apparatuses, systems, products and/or methods in the description and/or drawings not covered by the claims are presented as examples useful for understanding the invention.

According to a first example aspect, there is provided a process for producing at least one liquid transportation fuel component, the process comprising:
providing a paraffinic hydrocarbon feed comprising at least 60 wt-% paraffins of the total weight of the paraffinic hydrocarbon feed, of which paraffins at most 30 wt-% are isoparaffins;
subjecting the paraffinic hydrocarbon feed in a first reactor to hydroisomerisation (HI) in the presence of a hydroisomerisation catalyst to obtain a hydroisomerisation effluent;
subjecting the hydroisomerisation effluent to fractionation to separate from the fractionation at least a recycle stream comprising C16 n-paraffins and having a T5 temperature (5 vol-% recovered, EN ISO 3405-2019) of 270° C. or higher;
subjecting a second reactor feed comprising the recycle stream to hydrocracking in a second reactor in the presence of a hydrocracking catalyst to obtain a recycle effluent;
feeding the recycle effluent to the fractionation as a co-feed with the hydroisomerisation effluent; and
recovering from the fractionation at least one or more liquid transportation fuel components.

The present process enables obtaining improved yield and/or quality of the recovered fuel component(s), and particularly of a preferably recovered aviation fuel component, while the amount of low-profit products (fuel gas) may be kept at a low level. In the present process, recovery and recycle of a heavy fraction of the hydroisomerisation (HI) effluent to the hydrocracking, as specified, has proven successful in converting said heavy hydrocarbons into valuable fuel components, particularly in the aviation fuel range. Subjecting a highly isomerised recycle stream to hydrocracking, especially in the presence of a hydrocracking catalyst capable of both cracking and isomerisation, has proven extremely beneficial.

The inventors have found the fuel components obtainable by the present process to have very beneficial characteristics. Compared to liquid fuel components obtainable from a conventional process involving hydrodeoxygenation of fatty feedstock followed by hydroisomerisation, the fuel components obtainable by the present process may especially have higher content of i-paraffins, particularly multiple-branched i-paraffins, lower content of n-paraffins, and modified carbon number and/or boiling point distributions. Generally, these enhance cold properties of the fuel components obtainable by the present process, as well as fluidity/blendability, even at lower temperatures, making the fuel components obtainable by the present process desired and beneficial not only for use in fuel compositions, but also in a wide range of other uses.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 illustrates schematically an example embodiment of the present process involving hydrocracking, for producing at least one or more liquid transportation fuel components.

FIG. 2 illustrates schematically a comparative process involving hydrocracking, for producing at least one or more liquid transportation fuel components.

### DETAILED DESCRIPTION

In the following description, like reference signs denote like elements or steps.

All standards referred to herein are the latest revisions available at the filing date, unless otherwise mentioned.

Unless otherwise stated, regarding distillation characteristics, such as initial boiling points (IBP), final boiling points (FBP), T5 temperature (5 vol-% recovered), T95 temperature (95 vol-% recovered), and boiling ranges, reference is made to EN ISO 3405-2019. IBP is the temperature at the instant the first drop of condensate falls from the lower end of the condenser tube, and FBP is the maximum thermometer reading obtained during the test, usually occurring after the evaporation of all liquid from the bottom of the flask. For boiling point distribution reference may also be made to GC-based method (simdis) ASTM D2887-19e1, or for gasoline range hydrocarbons to ASTM D7096-19.

As used in the context of this disclosure, aviation fuel component refers to hydrocarbon compositions suitable for use in fuel compositions meeting standard specifications for aviation fuels, such as specifications laid down in ASTM D7566-21. Typically, such aviation fuel components boil, i.e. have IBP and FBP, within a range from about 100° C. to about 300° C., such as within a range from about 150° C. to about 300° C., as determined according to EN ISO 3405-2019.

As used in the context of this disclosure, diesel fuel component refers to hydrocarbon compositions suitable for use in fuel compositions meeting standard specifications for diesel fuels, such as specifications laid down in EN 590:2022 or in EN 15940:2016+A1:2018+AC:2019. Typically, such diesel fuel components boil, i.e. have IBP and FBP, within a range from about 160° C. to about 380° C., as determined according to EN ISO 3405-2019.

As used in the context of this disclosure, gasoline fuel component or naphtha refers to hydrocarbon components suitable for use in fuel compositions meeting standard specifications for gasoline fuels, such as specifications laid down in EN 228-2012+A1-2017. Typically, such gasoline fuel components boil, i.e. have IBP and FBP, within a range from about 25° C. to about 210° C., as determined according to EN ISO 3405-2019.

As used in the context of this disclosure, marine fuel component refers to hydrocarbon components suitable for use in fuel compositions meeting standard specifications for marine fuels, such as specifications laid down in ISO 8217-2017. Typically, such marine fuel components boil, i.e. have IBP and FBP, within a range from about 180° C. to about 600° C., such as from about 180° C. to about 400° C. as determined according to EN ISO 3405-2019.

As used herein hydrocarbons refer to compounds consisting of carbon and hydrogen. Hydrocarbons of particular interest in the present context comprise paraffins, n-paraffins, i-paraffins, monobranched i-paraffins, multiple-branched i-paraffins, olefins, naphthenes, and aromatics. Oxygenated hydrocarbons refer herein to hydrocarbons comprising covalently bound oxygen.

As used herein paraffins refer to non-cyclic alkanes, i.e. non-cyclic, open chain saturated hydrocarbons that are linear (normal paraffins, n-paraffins) or branched (isoparaffins, i-paraffins). In other words, paraffins refer herein to n-paraffins and/or i-paraffins.

In the context of the present disclosure, i-paraffins refer to branched open chain alkanes, i.e. non-cyclic, open chain saturated hydrocarbons having one or more alkyl side chains. Herein, i-paraffins having one alkyl side chain or branch are referred to as monobranched i-paraffins, and i-paraffins having two or more alkyl side chains or branches are herein referred to as multiple-branched i-paraffins. In other words, i-paraffins refer herein to monobranched i-paraffins and/or multiple-branched i-paraffins. The alkyl side chain(s) of i-paraffins may for example be C1-C9 alkyl side chain(s), preferably methyl side chain(s). The amounts of monobranched and multiple-branched i-paraffins may be given separately. The term “i-paraffins” refers to sum amount of any monobranched and any multiple-branched i-paraffins, if present, indicating the total amount of any i-paraffins present regardless the number of branches. Correspondingly, “paraffins” refers to sum amount of any n-paraffins, any monobranched i-paraffins, and any multiple-branched i-paraffins, if present.

In the context of the present disclosure, olefins refer to unsaturated, linear, branched, or cyclic hydrocarbons, excluding aromatic compounds. In other words, olefins refer to hydrocarbons having at least one unsaturated bond, excluding unsaturated bonds in aromatic rings.

As used herein, cyclic hydrocarbons refer to all hydrocarbons containing cyclic structure(s), including cyclic olefins, naphthenes, and aromatics. Naphthenes refer herein to cycloalkanes i.e. saturated hydrocarbons containing at least one cyclic structure, with or without side chains. As naphthenes are saturated compounds, they are compounds without aromatic ring structure(s) present. Aromatics refer herein to hydrocarbons containing at least one aromatic ring structure, i.e. cyclic structure having delocalized, alternating π bonds all the way around said cyclic structure.

In the context of the present disclosure, for gasoline fuel components, contents of n-paraffins, i-paraffins, monobranched i-paraffins, various multiple-branched i-paraffins, olefins, naphthenes, and aromatics are expressed as weight-% (wt-%) relative to the weight of the feed, stream, effluent, product, component, or sample in question or, when so defined, as weight-% (wt-%) relative to the (total) weight of paraffins, or (total) weight of i-paraffins of the feed, stream, effluent, product, component, or sample in question. Said contents may be determined by GC-FID/GC-MS method, preferably conducted as follows: GC-FID as disclosed in ASTM D6839 was run using parameters: column ZB-1 60 m, ID 0.25 mm, df 1.0 microns, or similar; oven 0° C. (2 min)-1.5° C./min-300° C. (5 min); injector and detector 300° C.; carrier gas helium 1.0 ml/min; detector gases H₂ 35 ml/min and air 350 ml/min; make up flow helium 30 ml/min; split flow 165:1 (165 ml/min). Individual compounds were identified using GC-MS (run parameters: ion source 230° C.; interface 280° C.; scan 25-280 m/z; scan speed 303; scan event time 0.88). Commercial tools (Shimadzu LabSolutions/GCMSSolutions and Agilent OpenLab) were used for identification of the detected compounds or hydrocarbon groups, and for determining their mass concentrations by application of response factors relative to n-heptane to the areas of detected peaks followed by normalization to 100 wt-% (for the liquid volume concentrations: by application of density factors to the calculated mass concentration of the detected peaks followed by normalization to 100 vol-%). Olefinic naphthenes are reported under naphthenes. The limit of quantitation for individual compounds of this method is 0.1 wt-%.

In the context of the present disclosure, for other compositions boiling at 36° C. or higher (at standard atmospheric pressure), contents of n-paraffins, i-paraffins, monobranched i-paraffins, various multiple-branched isoparaffins, naphthenes, and aromatics, are expressed as weight-% (wt-%) relative to the degassed weight of the feed, stream, effluent, product, component, or sample in question or, when so defined, as weight-% (wt-%) relative to the (total) weight of paraffins or (total) weight of i-paraffins of the feed, stream, effluent, product, component, or sample in question. Said contents may be determined by GC×GC-FID/GC×GC-MS method, preferably conducted as follows: GCxGC (2D GC) method was run as generally disclosed in UOP 990-2011 and by Nousiainen M. in the experimental section of his Master's Thesis Comprehensive two-dimensional gas chromatography with mass spectrometric and flame ionization detectors in petroleum chemistry, University of Helsinki, August 2017, with the following modifications. The GCxGC was run in reverse mode, using a semipolar column (Rxil7Sil) first and a non-polar column (Rxi5Sil) thereafter, followed by FID detector, using run parameters: carrier gas helium 31.7 cm/see (column flow at 40° C. 1.60 ml/min); split ratio 1:350; injector 280° C.; Column T program 40° C. (0 min) 5° C./min-250° C. (0 min)-10° C./min-300° C. (5 min), run time 52 min; modulation period 10 sec; detector 300° C. with H₂ 40 ml/min and air 400 ml/min; makeup flow helium 30 ml/min; sampling rate 250 Hz and injection size 0.2 microliters. Individual compounds were identified using GCxGC-MS, with MS-parameters: ion source 230° C.; interface 300° C.; scan range 25-500 amu; event time (sec) 0.05; scan speed 20000. Commercial tools (Shimadzu's LabSolutions, Zoex's GC Image) were used for data processing including identification of the detected compounds or hydrocarbon groups, and for determining their mass concentrations by application of response factors relative to n-heptane to the volumes of detected peaks followed by normalization to 100 wt-%. Olefins were lumped with naphthenes and heteroatomic species with aromatics, unless separately reported. The limit of quantitation for individual compounds of this method is 0.1 wt-%.

In the context of the present disclosure, various characteristics of the feeds, streams, effluents, products, components, or samples are determined according to the standard methods referred to or disclosed herein, as properly prepared. For example, cloud point is determined according to ASTM D 5771-17 from a degassed feed, stream, effluent, product, component, or sample.

Typically, the various paraffinic feeds, streams, effluents, and fuel components as recovered products or fractions thereof, referred to herein, may comprise in addition to hydrocarbons, also varying trace amounts of e.g. heteroatom-containing hydrocarbons and inorganic compounds as impurities, and the oxygenated hydrocarbon feed varying amounts of e.g. other heteroatom-containing hydrocarbons and inorganic compounds as impurities. Generally, the level of impurities in the main process streams is highest in the first parts of the process and decreases subsequently being negligible or even below detection limit in the recovered liquid transportation fuel component(s).

In the context of this disclosure, feed(s) to reactors, particularly to the first reactor and/or the second reactor, are defined so that H₂ possibly fed to the respective reactor, for example H₂ fed to the hydroisomerisation and H₂ fed to the hydrocracking, is excluded from the definition of the feed(s), unless otherwise mentioned.

As used herein, hydroisomerisation (HI) effluent refers to total HI effluent, degassed HI effluent, or degassed and stabilised HI effluent, as the case may be, and the term HI effluent may encompass each of these.

In the context of this disclosure, CX+ paraffins, CX+n-paraffins, CX+i-paraffins, CX+ mono-branched i-paraffins, CX+ multiple-branched i-paraffins, CX+ hydrocarbons, or CX+ fatty acids refer to paraffins, n-paraffins, i-paraffins, mono-branched i-paraffins, multiple-branched i-paraffins, hydrocarbons, or fatty acids, respectively, having a carbon number of at least X, where X is any feasible integer. It is understood that every compound falling within the definition is not necessarily present.

In the context of this disclosure, CY− paraffins, CY− n-paraffins, CY− i-paraffins, CY− mono-branched i-paraffins, CY− multiple-branched i-paraffins, CY− hydrocarbons, or CY− fatty acids refer to paraffins, n-paraffins, i-paraffins, mono-branched i-paraffins, multiple-branched i-paraffins, hydrocarbons, or fatty acids, respectively, having a carbon number of at most Y, wherein Y is any feasible integer. It is understood that every compound falling within the definition is not necessarily present.

In the context of this disclosure, CX_{Y}-CX_{Z} (or CX_{Y} to CX_{Z}) paraffins, CX_{Y}-CX_{Z} n-paraffins, CX_{Y}-CX_{Z} i-paraffins, CX_{Y}-CX_{Z} mono-branched i-paraffins, CX_{Y}-CX_{Z} multiple-branched i-paraffins, CX_{Y}-CX_{Z} hydrocarbons, or CX_{Y}-CX_{Z} fatty acids refer to a range of paraffins, n-paraffins, i-paraffins, mono-branched i-paraffins, multiple-branched i-paraffins, hydrocarbons, or fatty acids, respectively, where X_{Y} and X_{Z} are feasible end-value integers, wherein the carbon numbers within such range is as indicated by the end-value integers and any integers between said end-values, if present. However, paraffins, n-paraffins, i-paraffins, mono-branched i-paraffins, multiple-branched i-paraffins, hydrocarbons, or fatty acids, as the case may be, of all said carbon numbers within said range, particularly at or around the end points are not necessarily present, except when so expressly indicated. On the other hand, isomers, by definition, may comprise several compounds having the same carbon number, such as C15 isomers may comprise methyltetradecanes (different position of the methyl-branch), dimethyltridecanes (different positions of the two methyl-branches), etc, wherein “C15 isomers” comprises the sum amount of all such variants.

Typically, a sum amount as of weight or volume of paraffins, n-paraffins, i-paraffins, mono-branched i-paraffins, multiple-branched i-paraffins, hydrocarbons, or fatty acids, as defined each time, of all carbon numbers included is meant. For example, C15 to C22 n-paraffins refers to any n-paraffins within said range, such as C15, C16, C17, C18, C19, C20, C21, and C22 n-paraffins, even if the content of C15 n-paraffins was zero. In other words, a sum amount is obtainable by addition of 0 (referring to absent C15 n-paraffins) to the sum weight of all other C15 to C22 n-paraffins present.

Isomerisation converts at least a certain amount of n-paraffins to i-paraffins, especially to mono-branched i-paraffins. By (further) raising the isomerization degree, for example by increasing severity of the hydroisomerization as described hereinafter, more n-paraffins can be converted to i-paraffins, and mono-branched i-paraffins can be converted to multiple-branched i-paraffins, such as di-branched and/or tri-branched i-paraffins, even i-paraffins comprising more than three branches.

As used herein and in the context of the second reactor, degree of effective cracking refers to cracking that yields non-gaseous (NTP) cracking products, and especially as expressed as the ratio of the C8-C14 hydrocarbon content in the recycle effluent to the C8-C14 hydrocarbon content in the second reactor feed.

As used herein, wherever the reaction steps are defined to take place in “reactors”, such as the first reactor and second reactor, said expression is used for illustrative purposes mainly. A person skilled in the art contemplates that any “reactor” is in practice implemented as a reactor system that may consist of one or more reactors. Whether the reactors are actually arranged in a single reactor or several reactors is a matter of engineering, and may be influenced by practical issues such as maximum height of the facility at the site, reactor diameter, regulatory and maintenance issues at the site, wind conditions at the site, and/or available equipment. Analogously, the “fractionation” may take place in a fractionation system, typically comprising e.g. separation and distillation units, which may be arranged according to conventional engineering practice in the field.

Catalyst characteristics, such as total number of acid sites, refers in the context of this disclosure to the catalyst characteristics in their ready-to-use state, in the beginning of the present process.

As used herein, the term catalyst deactivation refers to decreased activity of the catalyst (reflected by the amount of unconverted feed in the reactor effluent) and/or decreased selectivity of the catalyst (reflected by decreased amount of desired reaction products in the reactor effluent) at a given time point (tn), compared to the activity and/or selectivity of the catalyst in the beginning of the present process (to). As used herein, the term catalyst deactivation is not limited to any specific deactivation type or mechanism, although the catalyst deactivation observed in the present process is generally believed to be attributed to poisoning and fouling phenomena, and encompasses both reversible and irreversible deactivation.

As used herein, the term renewable refers to compounds or compositions that are obtainable, derivable, or originating from plants and/or animals, including compounds or compositions obtainable, derivable, or originating from fungi and/or algae, in full or in part. As used herein, renewable compounds or compositions may comprise gene manipulated compounds or compositions. Renewable feeds, components, compounds, or compositions may also be referred to as biological feeds, components, compounds, or compositions, or as biogenic feeds, components, compounds, or compositions.

As used herein, the term fossil refers to compounds or compositions that are obtainable, derivable, or originating from naturally occurring non-renewable compositions, such as crude oil, petroleum oil/gas, shale oil/gas, natural gas, or coal deposits, and the like, and combinations thereof, including any hydrocarbon-rich deposits that can be utilised from ground/underground sources.

The term circular refers to recycled material typically originating from non-renewable sources. For example, the term circular may refer to recycled material originating from waste plastics. Said renewable, circular, and fossil compounds or compositions are considered differing from one another based on their origin and impact on environmental issues. Therefore, they may be treated differently under legislation and regulatory framework. Typically, renewable, circular, and fossil compounds or compositions are differentiated based on their origin and information thereof provided by the producer.

Chemically the renewable or fossil origin of any organic compounds, including hydrocarbons, can be determined by suitable method for analysing the content of carbon from renewable sources e.g. DIN 51637 (2014), ASTM D6866 (2020), or EN 16640 (2017). Said methods are based on the fact that carbon atoms of renewable or biological origin comprise a higher number of unstable radiocarbon (¹⁴C) atoms compared to carbon atoms of fossil origin. Therefore, it is possible to distinguish between carbon compounds derived from renewable or biological sources or raw material and carbon compounds derived from non-renewable or fossil sources or raw material by analysing the ratio of ¹²C and ¹⁴C isotopes. Thus, a particular ratio of said isotopes can be used as a “tag” to identify a renewable carbon compound and differentiate it from non-renewable carbon compounds. The isotope ratio does not change in the course of chemical reactions. Therefore, the isotope ratio can be used for identifying renewable compounds, components, and compositions and distinguishing them from non-renewable, fossil materials in reactor feeds, reactor effluents, separated product fractions and various blends thereof. Numerically, the biogenic carbon content can be expressed as the amount of biogenic carbon in the material as a weight percent of the total carbon (TC) in the material (in accordance with ASTM D6866 (2020) or EN 16640 (2017)). In the present context, the term renewable preferably refers to a material having a biogenic carbon content of more than 50 wt-%, especially more than 60 wt-% or more than 70 wt-%, preferably more than 80 wt-%, more preferably more than 90 wt-% or more than 95 wt-%, even more preferably about 100 wt-%, based on the total weight of carbon in the material (EN 16640 (2017)).

The present disclosure provides a process for producing at least one liquid transportation fuel component, the process comprising: providing a paraffinic hydrocarbon feed comprising at least 60 wt-% paraffins of the total weight of the paraffinic hydrocarbon feed, of which paraffins at most 30 wt-% are isoparaffins; subjecting the paraffinic hydrocarbon feed in a first reactor to hydroisomerisation (HI) in the presence of a hydroisomerisation catalyst to obtain a hydroisomerisation effluent; subjecting the hydroisomerisation effluent to fractionation to separate from the fractionation at least a recycle stream comprising C16 n-paraffins and having a T5 temperature (5 vol-% recovered, EN ISO 3405-2019) of 270° C. or higher; subjecting a second reactor feed comprising the recycle stream to hydrocracking (HC) in a second reactor in the presence of a hydrocracking catalyst to obtain a recycle effluent; feeding the recycle effluent to the fractionation as a co-feed with the hydroisomerisation effluent; and recovering from the fractionation at least one or more liquid transportation fuel components.

Preferably, the present process is a continuous process.

Typically, in the present process at least one or more of an aviation fuel component, a diesel fuel component, a gasoline fuel component, and/or a marine fuel component are recovered from the fractionation, preferably at least an aviation fuel component. With the present process, it is possible to obtain higher yield of aviation fuel component throughout the HI catalyst lifetime without a need to reduce the capacity of the HI in the first reactor, and/or to improve quality of the aviation fuel component, compared for example to conventional processes for producing fuel components by hydrodeoxygenation (HDO) and hydroisomerisation (HI) of renewable fats and oils. Experimentally, test runs conducted according to the present process have shown that up to 64 wt-% of the recycle stream can still be converted to a renewable aviation fuel component. The yield increase is believed to be contributed by cracking of the heavy molecules of the recycle stream particularly to C8-C14 range, without significantly decreasing the isomerisation degree.

With the present process it is possible to produce, even towards the end of the HI catalyst lifetime, an aviation fuel component having excellent cold properties and hence usable in aviation fuels with high blending ratio or even as such, i.e. unblended, when suitably additised. Also, the present process enables extending the HI catalyst lifetime and enables utilisation of a broader range of feeds, including heavier and more impure feeds, compared to conventional processes for producing fuel components by HDO and HI of renewable fats and oils. Furthermore, the present process enables flexible adjustment of product selectivity towards the various liquid transportation fuel components, such as gasoline fuel component, aviation fuel component, diesel fuel component, and/or marine fuel component, based on e.g. market dynamics, even towards the end of the HI catalyst lifetime.

The present process suggests subjecting a heavy fraction of the HI effluent, i.e. recycle stream, to hydrocracking, which hydrocracking cracks longer paraffin chains for example to paraffins boiling in the aviation fuel range, and may even isomerise n-paraffins in the second reactor feed as well as n-paraffins formed in the course of cracking reactions, and further isomerise isoparaffins by increasing the number of branches in isoparaffin molecules e.g. producing multiple-branched isoparaffins. Typically, the recycle stream subjected to hydrocracking comprises compounds boiling above targeted aviation fuel boiling range, and/or n-paraffins, particularly C16+n-paraffins, affecting cold properties. By operating the process of the present disclosure, high isomerisation degree may be reached in the first reactor. This is beneficial for achieving a desired degree of effective cracking in the second reactor at milder operating conditions (compared to a less isomerised second reactor feed). Preferably, by operating the process of the present disclosure, also the content of multiple-branched isoparaffins in the HI effluent is efficiently elevated, compared to their content in the paraffinic hydrocarbon feed, which may also contribute beneficially to the degree of effective cracking, particularly to C8-C14 hydrocarbons but also to lighter non-gaseous hydrocarbons, in the second reactor. Multiple-branched isoparaffins are also believed to increase the isoparaffin content of the recycle effluent (compared to second reactor feeds with lower content of or no multiple-branched isoparaffin). Enhanced degree of effective cracking without excess formation of gaseous hydrocarbons in the second reactor, and an increased isoparaffin content of the recycle effluent may be beneficial both for the yield and the quality of the recovered transportation fuel component(s), especially for the yield and quality of the preferably recovered aviation fuel component. The hydrocracking may increase the yield of an aviation fuel component as well as improve its quality, for example its cold properties, especially lower its freezing point and/or viscosity at subzero temperatures such as at −20° C.

During continued operation of catalytic hydroisomerisation and hydrocracking, the catalysts deactivate gradually for example due to impurities in process streams and coking. The present process is highly flexible and involves various possibilities to adjust yield and/or quality of the recovered liquid transportation fuel component(s) and to prolong the lifetime of the HI and HC catalysts. Adjusting the amount of the recycle stream subjected to hydrocracking and/or the amount of heavies removed from the process as diesel fuel, marine fuel, or other heavy product component are convenient means for adjusting the yield and/or quality of the recovered liquid transportation fuel component(s), and to respond to the catalyst deactivation, or changing market needs. Additionally, when subjecting to hydrocracking just the recycle stream, i.e. just a heavy fraction of the HI effluent, no gaseous impurities typically present in the gaseous phase of the HI effluent get into contact with the hydrocracking (HC) catalyst. The various possibilities to compensate particularly the HI catalyst deactivation enable use of paraffinic feeds with higher impurity content, compared to conventional processes for producing liquid fuel components by HDO and HI of renewable fats and oils. Also, the hydrocracking step enables use of feeds comprising heavier and longer chain molecules compared to said conventional processes for producing liquid fuel components, typically diesel components, while being able to produce lower-boiling liquid transportation fuel components, such as aviation fuel component and/or gasoline fuel component, with good yields and quality.

In certain preferred embodiments of the present process, the second reactor feed further comprises a portion of the HI effluent (other than the recycle stream). In these embodiments, the portion may be obtained e.g. by simply splitting the total or preferably degassed HI effluent between the fractionation and the second reactor, using e.g. a fixed or preferably gradually adjusted ratio. These embodiments provide further flexibility for operating the present process, and possibility to adjust the process even more precisely in order to meet targeted yields and qualities of more than one recovered fuel component at a time. In this way it may be possible to avoid situations where targeted yield and quality of one recovered fuel component are met but at the expense of producing over-quality of another recovered fuel component (e.g. producing a diesel fuel component having unnecessarily low cloud point).

In the present process, the paraffinic hydrocarbon feed subjected to hydroisomerisation in the first reactor comprises at least 60 wt-% paraffins of the total weight of the paraffinic hydrocarbon feed, of which paraffins at most 30 wt-% are isoparaffins. This means that when the paraffinic hydrocarbon feed comprises 60 wt-% paraffins of the total weight of the paraffinic hydrocarbon feed, then at most 30 wt-% of the total weight of paraffins in the paraffinic feed, i.e. at most 18 wt-% of the total weight of the paraffinic hydrocarbon feed, are isoparaffins. Preferably, the paraffinic hydrocarbon feed comprises at least 70 wt-%, more preferably at least 80 wt-%, even more preferably at least 90 wt-% paraffins of the total weight of the paraffinic hydrocarbon feed. The paraffinic hydrocarbon feed of the present disclosure may comprise even at least 95 wt-% paraffins of the total weight of the paraffinic hydrocarbon feed or consist essentially of paraffins. The paraffinic hydrocarbon feed of the present disclosure may contain minor amounts of olefins, preferably less than 5 wt-%, more preferably less than 1 wt-%, based on the total weight of the paraffinic hydrocarbon feed, as well as minor amounts of aromatics and/or naphthenes.

An advantage of using a highly paraffinic hydrocarbon feed in the present process is that paraffins are isomerised relatively easily and at milder conditions when subjected to HI compared to e.g. cyclic hydrocarbons. Also, paraffins crack relatively easily and at milder conditions when subjected to hydrocracking.

Of the paraffins in the paraffinic hydrocarbon feed of the present disclosure, preferably at most 25 wt-%, more preferably at most 20 wt-%, and even more preferably at most 15 wt-% are isoparaffins. For example, of the paraffins in the paraffinic hydrocarbon feed from 1 wt-% to 30 wt-%, or from 1 wt-% to 20 wt-%, or from 2 wt-% to 30 wt-%, or from 2 wt-% to 20 wt-% may be isoparaffins.

A high weight-ratio (wt-%:wt-%) of n-paraffins to isoparaffins in the paraffinic hydrocarbon feed may contribute to limiting cracking side-reactions during HI in the first reactor as n-paraffins are less prone to crack compared to isoparaffins of same carbon number. However, the presence of a certain amount of isoparaffins in the paraffinic hydrocarbon feed may still be beneficial. Compared to otherwise similar feeds but without isoparaffin content, paraffinic hydrocarbon feeds containing a certain amount of isoparaffins may yield a HI effluent with a higher content of multiple-branched isoparaffins.

Preferably, the paraffinic hydrocarbon feed of the present disclosure comprises at least 70 wt-%, preferably at least 80 wt-%, more preferably at least 90 wt-%, even more preferably at least 95 wt-% hydrocarbons having a carbon number within the range from C12 to C30, of the total weight of the paraffinic hydrocarbon feed. In certain particularly preferred embodiments, the paraffinic hydrocarbon feed comprises at least 70 wt-%, preferably at least 80 wt-%, more preferably at least 90 wt-%, even more preferably at least 95 wt-% hydrocarbons having a carbon number within the range from C14 to C22 of the total weight of the paraffinic hydrocarbon feed. Paraffinic hydrocarbon feeds having a high content of C12 to C30 hydrocarbons are preferred as they allow good yields of two or more liquid transportation fuel components of different kinds. C14 to C22 hydrocarbons are particularly preferred for the same reason, and also because they are readily available for example from conventional hydrodeoxygenation (HDO) processes of vegetable oils, animal fats, and/or microbial oils, comprising fatty acids.

To increase the yield of aviation fuel component and/or diesel fuel component, it is particularly preferred that the paraffinic hydrocarbon feed comprises at least 50 wt-%, preferably at least 60 wt-%, more preferably at least 70 wt-%, even more preferably at least 80 wt-% or at least 90 wt-% C16+ paraffins of the total weight of paraffins in the paraffinic hydrocarbon feed. In certain embodiments, the paraffinic hydrocarbon feed comprises at least 50 wt-% C17+ paraffins of the total weight of paraffins in the paraffinic hydrocarbon feed. This kind of compositions are attainable by suitably selecting heavier paraffinic hydrocarbon feeds, particularly by suitably selecting feedstocks such as oxygenated hydrocarbons, for producing them. Examples of suitable heavier oxygenated hydrocarbon feeds include oil from energy crops such as Brassica species, algal oils, crude tall oil (CTO), tall oil fatty acids (TOFA), tall oil pitch (TOP), and/or lignocellulosics-originating feeds. C17+ paraffins are also obtainable by Fischer-Tropsch conversion of syngas.

The paraffinic hydrocarbon feed may comprise any suitable paraffinic hydrocarbon composition or combinations thereof. Preferably, in the present process the step of providing the paraffinic hydrocarbon feed comprises subjecting a hydrotreatment feed to a catalytic hydrotreatment, preferably subjecting an oxygenated hydrocarbon feed to catalytic hydrodeoxygenation, wherein the hydrotreatment feed preferably comprises at least one or more of vegetable oil(s), animal fat(s), microbial oil(s), thermally liquefied organic waste and residue(s), and/or enzymatically liquefied organic waste and residue(s), more preferably the oxygenated hydrocarbon feed comprises at least one or more of vegetable oil(s), animal fat(s), and/or microbial oil(s), and/or subjecting a syngas to a Fischer-Tropsch conversion to obtain a paraffinic FT effluent; subjecting the paraffinic hydrotreatment effluent and/or paraffinic FT effluent to gas-liquid separation, and/or a paraffinic feed fractionation to provide the paraffinic hydrocarbon feed. By gas-liquid separation is meant removing at least compounds that are gaseous at NTP.

While e.g. paraffinic FT effluents of fossil origin are readily available (in addition to FT effluents of renewable origin), preferably the paraffinic hydrocarbon feed of the present disclosure is at least partially renewable, i.e. comprises biogenic components. In certain preferred embodiments, the biogenic carbon content of the paraffinic hydrocarbon feed is at least 50 wt-%, preferably at least 70 wt-%, more preferably at least 90 wt-%, even more preferably at least 95 wt-%, or even about 100 wt-%, based on the total weight of carbon (TC) of the paraffinic hydrocarbon feed, preferably as determined according to EN 16640 (2017).

In certain embodiments, the paraffinic hydrocarbon feed comprises or consists essentially of a degassed paraffinic Fischer-Tropsch effluent, or a fraction thereof. Fischer-Tropsch process involves a catalytic conversion of syngas comprising carbon monoxide and hydrogen, typically to a substantially Gaussian distribution of hydrocarbon chains, mainly n-paraffins, having a wide carbon chain length distribution, such as from C2 to C100+, typically from about C5 to about C50. FT effluents are typically highly paraffinic comprising mainly n-paraffins. The catalytic FT conversion of syngas may result in a minor degree of isomerisation, the FT effluent typically comprising about 10 wt-% or less isoparaffins of the total weight of the FT effluent. The syngas used in the FT process may be produced from renewable materials, natural gas, coal, or a combination thereof.

Preferably, the paraffinic hydrocarbon feed of the present disclosure comprises or consists essentially of a degassed paraffinic hydrotreatment effluent, or a fraction thereof, particularly as obtained by catalytic hydrotreatment of a hydrotreatment feed comprising at least one or more of vegetable oils, animal fats, microbial oils, thermally liquefied organic waste and residues, and/or enzymatically liquefied organic waste and residues, more preferably at least one or more of vegetable oil(s), animal fat(s), and/or microbial oil(s), to obtain a paraffinic hydrotreatment effluent, followed by subjecting the paraffinic hydrotreatment effluent to a gas-liquid separation, and optionally to a paraffinic feed fractionation to provide the degassed hydrotreatment effluent, or a fraction thereof.

By the term “catalytic hydrotreatment”, sometimes also referred to as hydroprocessing, is meant a catalytic process of treating organic material by means of molecular hydrogen. Preferably, catalytic hydrotreatment removes oxygen from organic oxygen compounds as water i.e. hydrodeoxygenation (HDO), sulphur from organic sulphur compounds as dihydrogen sulphide (H₂S), i.e. hydrodesulphurisation, (HDS), nitrogen from organic nitrogen compounds as ammonia (NH₃), i.e. hydrodenitrogenation (HDN), halogens, for example chlorine from organic chloride compounds as hydrochloric acid (HCl), i.e. hydrodechlorination (HDCl), and/or metals by hydrodemetallization, and/or hydrogenates olefinic bonds if present in the hydrotreatment feed. Depending on the composition of the hydrotreatment feed, different reactions may occur and/or prevail.

Preferably, the paraffinic hydrocarbon feed of the present disclosure comprises or consists essentially of a degassed hydrodeoxygenation (HDO) effluent, or a fraction thereof, particularly as obtained by catalytic hydrodeoxygenation (HDO) of an oxygenated hydrocarbon feed comprising at least one or more of vegetable oil(s), animal fat(s), and/or microbial oil(s), to obtain a paraffinic HDO effluent, followed by subjecting the paraffinic HDO effluent to a gas-liquid separation, and optionally to a paraffinic feed fractionation to provide the degassed HDO effluent, or a fraction thereof.

In certain embodiments, providing the paraffinic hydrocarbon feed comprises subjecting an oxygenated hydrocarbon feed, preferably in a hydrodeoxygenation (HDO) reactor, to hydrodeoxygenation in the presence of a hydrodeoxygenation catalyst to obtain a hydrodeoxygenation effluent, and subjecting the hydrodeoxygenation effluent to gas-liquid separation, and optionally to paraffinic feed fractionation to obtain as the paraffinic hydrocarbon feed the degassed hydrodeoxygenation effluent or a fraction thereof, wherein the hydrodeoxygenation is preferably conducted at a temperature within a range from 200° C. to 500° C., a pressure within a range from 1 MPa to 20 MPa, a H₂ partial pressure at the inlet of the reactor within a range from 1 MPa to 20 MPa, a weight hourly space velocity within a range from 0.1 to 10 kg oxygenated hydrocarbon feed per kg catalyst per hour, and a H₂ to oxygenated hydrocarbon feed ratio selected from a range from 50 to 2000 normal liters H₂ per liter oxygenated hydrocarbon feed. Preferably, the oxygenated hydrocarbon feed comprises at least one or more of vegetable oil(s), animal fat(s), and/or microbial oil(s). Hydrodeoxygenation is preferably conducted as described in prior art publications, such as F1100248B, EP1741768A1, EP2155838B1 or F1129220 B1.

The optional paraffinic feed fractionation is typically conducted in a fractionation unit different from the fractionation unit(s) used to recover the liquid transportation fuel component(s) and/or to separate the recycle stream. The optional paraffinic feed fractionation may be regarded separate from the fractionation of the present process, which fractionation of the present process comprises fractionation to recover the liquid transportation fuel component(s) and/or to separate the recycle stream.

Preferably, the HDO catalyst is a sulphided catalyst comprising at least one or more metals from Group VIII of the Periodic Table and/or from Group VIB of the Periodic Table, preferably at least one or more of Ni, Mo, W, and/or Co, even more preferably at least one or more of Ni and/or Co and Mo and/or W, such as NiMo, CoMo, NiCoMo, NiW, and/or NiMoW. These catalysts are efficient, readily available, and tolerate typical impurities of fatty feedstocks well. If using a catalyst having hydrodewaxing properties, such as a catalyst containing NiW, in the hydrodeoxygenation as the hydrodeoxygenation catalyst or as a co-catalyst, HDO effluent with somewhat elevated isoparaffin content may be attained.

In the present process the paraffinic hydrocarbon feed is subjected in a first reactor to hydroisomerisation in the presence of a HI catalyst to obtain a HI effluent. Generally, in the context of the present disclosure, HI of the paraffinic hydrocarbon feed in the first reactor is operated so that isomerisation reactions prevail while cracking reactions are controlled or suppressed.

Preferably, the hydroisomerisation in the first reactor is conducted at a temperature within a range from 200° C. to 500° C., preferably from 230° C. to 500° C., more preferably from 250° C. to 450° C., even more preferably from 280° C. to 400° C., a pressure within a range from 1 MPa to 10 MPa, preferably from 2 MPa to 8 MPa or from 3 MPa to 10 MPa, a H₂ partial pressure at the inlet of the first reactor within a range from 1 MPa to 10 MPa, preferably from 2 MPa to 8 MPa, a weight hourly space velocity within a range from 0.1 to 10, preferably from 0.2 to 8, more preferably from 0.4 to 6 kg paraffinic hydrocarbon feed per kg catalyst per hour, and a H₂ to paraffinic hydrocarbon feed ratio within a range from 10 to 2000, preferably from 50 to 1000 normal liters H₂ per liter paraffinic hydrocarbon feed.

According to certain embodiments, the hydroisomerisation in the first reactor is conducted at a temperature within a range from 200° C. to 500° C., a pressure within a range from 1 MPa to 10 MPa, a H₂ partial pressure at the inlet of the first reactor within a range from 1 MPa to 10 MPa, a weight hourly space velocity within a range from 0.1 to 10 kg paraffinic hydrocarbon feed per kg catalyst per hour, and a H₂ to paraffinic hydrocarbon feed ratio within a range from 10 to 2000 normal liters H₂ per liter paraffinic hydrocarbon feed.

According to certain particularly preferred embodiments, the hydroisomerisation in the first reactor is conducted at a temperature within a range from 230° C. to 500° C., a pressure within a range from 2 MPa to 8 MPa, a H₂ partial pressure at the inlet of the first reactor within a range from 2 MPa to 8 MPa, a weight hourly space velocity within a range from 0.2 to 8 kg paraffinic hydrocarbon feed per kg catalyst per hour, and a H₂ to paraffinic hydrocarbon feed ratio within a range from 50 to 1000 normal liters H₂ per liter paraffinic hydrocarbon feed.

The HI effluent is preferably subjected to gas-liquid separation, i.e. removal of at least compounds that are gaseous at NTP, including e.g. NH₃ and/or H₂S possibly present in the gaseous phase of the HI effluent. This can be done before directing the HI effluent to fractionation, e.g. as an integral step within the first reactor, or as part of the fractionation.

Degree of isomerisation of the HI effluent may be improved by increasing severity of the HI e.g. by at least one or more of: decreasing WHSV, increasing temperature, and/or increasing pressure. When using fresh HI catalyst, high severity HI conditions may be reached at lower temperature and/or pressure, and/or using higher WHSV. Towards the end of the HI catalyst lifetime higher temperature and/or pressure, and/or lower WHSV may be needed to reach even medium severity HI. In the present context, HI that yields liquid effluents having, as wt-% of paraffins in the liquid effluent, total i-paraffins content within a range from 50 wt-% to 85 wt-% and multiple-branched i-paraffins content at most 25 wt-%, or total i-paraffins content within a range from 85 to 95 wt-% and multiple-branched i-paraffins content within a range from 25 to 55 wt-%, or total i-paraffins content at least 95 wt-% and multiple-branched i-paraffins content more than 55 wt-%, is generally regarded as HI of low severity or medium severity or high severity, respectively, although these content ranges are merely for illustrating the order of magnitude, and may overlap to some extent, and vary from case to case.

Preferably, the hydroisomerisation in the first reactor is operated so that the ratio of the wt-% amount of isoparaffins of the total weight of paraffins in the HI effluent to the wt-% amount of isoparaffins of the total weight of paraffins in the paraffinic hydrocarbon feed is at least 2, or at least 4, or at least 6, or at least 8, or at least 10, or at least 12, and/or so that the ratio of the wt-% amount of multiple-branched isoparaffins of the total weight of paraffins in the HI effluent to the wt-% amount of multiple-branched isoparaffins of the total weight of paraffins in the paraffinic hydrocarbon feed is at least 2, or at least 4, or at least 6, or at least 8, or at least 10, or at least 12, and/or so that the (total) HI effluent comprises C1-C4 hydrocarbons less than 20 wt-% or less than 10 wt-%, preferably less than 5 wt-%, more preferably less than 3 wt-% of the total weight of the HI effluent. These may be achieved especially when operating the first reactor within the HI operating conditions and/or using the HI catalyst(s) and/or the paraffinic hydrocarbon feed as defined herein.

Typically, the HI effluent comprises at least 60 wt-%, preferably at least 70 wt-%, more preferably at least 80 wt-%, even more preferably at least 90 wt-% or at least 95 wt-% paraffins of the total weight of the HI effluent. In certain embodiments, the HI effluent may even consist essentially of paraffins.

Typically, the HI effluent comprises at least 50 wt-%, preferably at least 60 wt-%, more preferably at least 70 wt-%, even more preferably at least 80 wt-% isoparaffins of the total weight of paraffins in the HI effluent, and optionally multiple-branched isoparaffins at least 5 wt-%, more preferably at least 10 wt-%, even more preferably at least 15 wt-%, or at least 20 wt-% of the total weight of paraffins in the HI effluent. Typically, the HI effluent comprises at most 75 wt-%, or at most 70 wt-% or at most 60 wt-%, such as at most 50 wt-%, or at most 40 wt-%, sometimes at most 30 wt-%, or even at most 20 wt-% multiple-branched isoparaffins of the total weight of paraffins in the HI effluent. Typically, the HI effluent has a cloud point less than 0° C., preferably less than −5° C., more preferably less than −8° C., even more preferably less than −10° C., or less than −15° C. (ASTM D 5771-17).

Presence of multiple-branched isoparaffins in the HI effluent may be considered beneficial as it may contribute beneficially to the degree of effective cracking in the second reactor. When a desired degree of effective cracking, particularly to C8-C14 hydrocarbons but also to lighter non-gaseous hydrocarbons, is achieved in the second reactor at milder operating conditions, excessive cracking may be avoided, and formation of gaseous hydrocarbons reduced. Also, an increased content of multiple-branched isoparaffins in the HI effluent may be considered beneficial in that it may improve the cold properties of the recovered liquid transportation fuel component(s), especially the cold properties of aviation fuel component and/or diesel fuel component, and/or RON of gasoline fuel component. Without being bound to any theory, it is believed that a multiple-branched isoparaffin is more likely to form upon cracking in the second reactor two branched paraffin molecules instead of one branched and one n-paraffin, hence increasing the isoparaffin content of the recycle effluent.

The present process comprises subjecting a second reactor feed comprising the recycle stream to hydrocracking in a second reactor in the presence of a hydrocracking (HC) catalyst to obtain a recycle effluent. Hydrocracking isomerised heavy paraffins in the recycle stream increases yield of aviation fuel component, and provides flexibility to the use of different paraffinic hydrocarbon feeds, particularly to the use of oxygenated hydrocarbon feeds converted thereto. Generally hydrocracking in the second reactor is operated so that cracking reactions, especially those enhancing the degree of effective cracking, are more abundant than in the hydroisomerisation in the first reactor. Preferably cracking reactions, especially those enhancing the degree of effective cracking, prevail in the hydrocracking in the second reactor, yet generally without excessive cracking and excessive fuel gas formation.

The second reactor feed may further comprise a portion of the HI effluent (other than the recycle stream), preferably as degassed, i.e. after subjecting the HI effluent to gas-liquid separation to remove at least compounds that are gaseous at NTP. In these embodiments the portion may be obtained e.g. by simply splitting the total or preferably degassed HI effluent between the fractionation and the second reactor, using e.g. a fixed or preferably gradually adjusted ratio. These embodiments provide further flexibility for operating the process, including further possibility to adjust ratio of the recovered fuel components and their qualities, as explained in the foregoing. The amount of such portion of the HI effluent fed to the second reactor may vary but is generally just a minor portion. Hence in certain preferred embodiments of the present process, the second reactor feed further comprises, based on the total weight of the second reactor feed, less than 50 wt-%, preferably less than 30 wt-%, more preferably less than 10 wt-% of the HI effluent, preferably as degassed.

In certain preferred embodiments, the second reactor feed consists essentially of the recycle stream and optionally a portion of the hydroisomerisation effluent (other than the recycle stream).

In the present process the hydrocracking in the second reactor may be conducted at a temperature within a range from 200° C. to 450° C., preferably from 220° C. to 430° C., more preferably from 280° C. to 350° C., a pressure within a range from 0.4 MPa to 8 MPa, preferably from 1 MPa to 7 MPa, more preferably from 2.5 MPa to 7 MPa, a H₂ partial pressure at the inlet of the second reactor within a range from 0.4 MPa to 8 MPa, preferably from 1 MPa to 7 MPa, more preferably from 2.5 MPa to 7 MPa, a weight hourly space velocity within a range from 0.1 to 10, preferably from 0.2 to 8, more preferably from 0.4 to 6, even more preferably from 0.5 to 1.5 kg second reactor feed per kg catalyst per hour, and a H₂ to second reactor feed ratio within a range from 10 to 2000, preferably from 50 to 1000 normal liters H₂ per liter second reactor feed. Typically in the present process, the hydrocracking in the second reactor is conducted at a temperature within a range from 200° C. to 450° C., a pressure within a range from 0.4 MPa to 8 MPa, a H₂ partial pressure at the inlet of the second reactor within a range from 0.4 MPa to 8 MPa, preferably from 1 MPa to 7 MPa, a weight hourly space velocity within a range from 0.1 to 10 kg second reactor feed per kg catalyst per hour, and a H₂ to second reactor feed ratio within a range from 10 to 2000, preferably from 50 to 1000 normal liters H₂ per liter second reactor feed.

According to certain preferred embodiments, the hydrocracking in the second reactor is conducted at a temperature within a range from 220° C. to 430° C., a pressure within a range from 1 MPa to 7 MPa, a weight hourly space velocity within a range from 0.2 to 8 kg second reactor feed per kg catalyst per hour, and a H₂ to second reactor feed ratio within a range from 50 to 1000 normal liters H₂ per liter second reactor feed. In further preferred embodiments, the hydrocracking in the second reactor is conducted at a temperature within a range from 280° C. to 350° C., a pressure within a range from 2.5 MPa to 7 MPa, a H₂ partial pressure at the inlet of the second reactor within a range from 2.5 MPa to 7 MPa, a weight hourly space velocity within a range from 0.4 to 6 kg second reactor feed per kg catalyst per hour, and a H₂ to second reactor feed ratio within a range from 50 to 1000 normal liters H₂ per liter second reactor feed. When operating the HC at lower temperatures and sufficiently high pressures, aromatizing side reactions may be better suppressed or even dearomatisation enhanced.

Preferably, hydrocracking in the second reactor is operated so that the ratio of the wt-% amount of isoparaffins of the total weight of paraffins in the recycle effluent to the wt-% amount of isoparaffins of the total weight of paraffins in the second reactor feed is at least 0.5, or at least 0.7, or at least 0.8, or at least 0.9, or at least 1.0; and/or so that the ratio of the C8-C14 hydrocarbon content in the recycle effluent to the C8-C14 hydrocarbon content in the second reactor feed is at least 1.1, preferably at least 1.3, more preferably at least 1.5, even more preferably at least 1.8 or at least 2.0.

In certain preferred embodiments, hydrocracking in the second reactor is operated so that the ratio of content of C1-C4 hydrocarbons formed during hydrocracking in the (total) recycle effluent to the content of C1-C4 hydrocarbons in the (total) HI effluent is within a range from 1.1 to 5.0, preferably from 1.1 to 4.0, more preferably from 1.2 to 3.0; and/or so that the (total) recycle effluent comprises C1-C4 hydrocarbons less than 20 wt-%, or less than 10 wt-%, or less than 5 wt-% of the total weight of the recycle effluent.

These may be achieved especially when using the second reactor feed as specified in the foregoing and/or operating the second reactor within the hydrocracking operating conditions specified in the foregoing and/or in the presence of a HC catalyst as defined hereinafter, particularly in the presence of a non-sulphided bifunctional HC catalyst, preferably a non-sulphided bifunctional HC catalyst comprising at least one or more Group VIII noble metals, more preferably Pt and/or Pd.

Typically, the recycle effluent comprises at least 60 wt-%, preferably at least 70 wt-%, more preferably at least 80 wt-%, even more preferably at least 90 wt-% or at least 95 wt-% paraffins of the total weight of the recycle effluent. The recycle effluent may even consist essentially of paraffins.

According to certain preferred embodiments, the recycle effluent comprises at least 50 wt-%, preferably at least 60 wt-%, more preferably at least 70 wt-%, even more preferably at least 80 wt-% isoparaffins of the total weight of paraffins in the recycle effluent, and/or at least 3 wt-%, or at least 5 wt-%, preferably at least 10 wt-%, more preferably at least 15 wt-%, even more preferably at least 20 wt-% multiple-branched isoparaffins of the total weight of paraffins in the recycle effluent.

Preferably, the first reactor is operated at a higher temperature than the second reactor, when comparing the temperatures at the reactor inlets. The compared temperatures are the temperatures at the inlet of the first reactor and at the inlet of the second reactor, respectively, at a given time point, including short time intervals. In other words, the comparison is not made in this context between the highest temperatures during the whole run from starting the process to stopping it.

By operating the first reactor and the second reactor within the operating condition ranges specified in the foregoing, and especially when operating the first reactor at higher temperature than the second reactor, high degree of isomerisation may be reached in the first reactor while thermal cracking is controlled, decreased, or minimized in the second reactor, and content of multiple-branched isoparaffins in the HI effluent may be increased. At the same time desired degree of effective cracking may be achieved in the second reactor at milder operating conditions, especially at lower temperature, which improves the yield of hydrocarbons in the aviation fuel and gasoline boiling range, without excessive thermal cracking leading to gas formation.

The present process comprises subjecting the HI effluent to fractionation to separate from the fractionation at least a recycle stream comprising C16 n-paraffins and having a T5 temperature (5 vol-% recovered, EN ISO 3405-2019) of 270° C. or higher. HI effluent may be subjected to fractionation as such or as degassed, i.e. after subjecting the HI effluent to gas-liquid separation to remove at least compounds that are gaseous at NTP, or the HI effluent, preferably as degassed, can be split between the fractionation and the second reactor, generally major portion being subjected to the fractionation, as discussed in the foregoing.

Preferably, the recycle stream has a T5 temperature of 275° C. or higher. In certain preferred embodiments, the recycle stream has a T5 temperature within a range from 270° C. to less than 300° C., preferably within a range from 270° C. to less than 295° C., more preferably within a range from 270° C. to less than 290° C.; and/or an initial boiling point (IBP, EN ISO 3405-2019) less than 290° C., preferably less than 288° C., more preferably less than 285° C., or less than 280° C. The recycle stream may have the FBP of the total feed subjected to fractionation, i.e. the recycle stream may comprise the heavy bottom of the total feed subjected to fractionation.

The T5 temperature of the recycle stream is preferably selected so that at least a portion of the C16 n-paraffins present in the total feed subjected to the fractionation, such as C16 n-paraffins present in the HI effluent, if any, are recovered in the recycle stream. Recovering C16 n-paraffins in the recycle stream may be attained by suitably selecting the T5 temperature and/or IBP of the recycle stream. C16 n-paraffins have a boiling point of 287° C. (at normal pressure), but as fractionations, such as distillation separations, are not perfectly sharp, C16 n-paraffins may be recovered over a temperature range around that boiling point.

Recycling at least some of C16 n-paraffins to the second reactor to be subjected to hydrocracking is beneficial as C16 n-paraffins have a relatively high melting point. Hence, the presence of C16 n-paraffins in any significant amounts for example in the recovered aviation fuel component might even render it unusable in aviation fuel compositions, due to poor cold properties, especially poor freezing point, and/or poor i.e. high kinematic viscosity at subzero temperatures such as −20° C. or −40° C. In any event, C16 n-paraffins in the recovered aviation fuel component impairs its cold properties i.e. increases one or more of cloud point, freezing point, pour point, and/or cold filter plugging point, and/or subzero kinematic viscosity, compared to aviation fuel components with less or without C16 n-paraffin content. Preferably, the recycle stream comprises at least 20 wt-% or at least 30 wt-%, more preferably at least 40 wt-% or at least 50 wt-% of the C16 n-paraffins in the total feed subjected to fractionation. The amount of n-paraffins, including C16 n-paraffins, in the total feed subjected to the fractionation may increase upon HI catalyst deactivation, and may also be formed by cracking in the second reactor.

In certain particularly preferred embodiments, the recycle stream comprises at least 85 wt-%, preferably at least 90 wt-%, more preferably at least 95 wt-% C16+ paraffins of the total weight of paraffins in the recycle stream. Subjecting C16+ paraffins to hydrocracking in the second reactor is beneficial in that it may increase yield and/or improve quality of aviation fuel component. C16+ n-paraffins have poor cold properties while C18+ n-paraffins generally boil outside the aviation fuel boiling range.

Typically, the recycle stream comprises at least 60 wt-%, preferably at least 70 wt-%, more preferably at least 80 wt-%, even more preferably at least 90 wt-% or at least 95 wt-% paraffins of the total weight of the recycle stream, or the recycle stream may even consist essentially of paraffins. In particularly preferred embodiments, the recycle stream comprises at least 50 wt-%, preferably at least 60 wt-%, more preferably at least 70 wt-%, or at least 80 wt-% and/or up to about 100 wt-%, or at most 98 wt-% isoparaffins of the total weight of paraffins in the recycle stream, and/or at least 5 wt-%, or at least 10 wt-%, preferably at least 15 wt-%, or at least 20 wt-% multiple-branched isoparaffins of the total weight of paraffins in the recycle stream. Typically, the recycle stream comprises at most 95 wt-% or at most 90 wt-%, or at most 80 wt-%, or at most 70 wt-%, such as at most 60 wt-%, or at most 50 wt-%, or at most 40 wt-%, sometimes at most 30 wt-%, or even at most 20 wt-% multiple-branched isoparaffins of the total weight of paraffins in the recycle stream, typically ranging from 5 wt-% to 95 wt-%, preferably from 5 wt-% to 80 wt-%, or from 5 wt-% to 70 wt-%, such as from 10 wt-% to 70 wt-%, or from 15 wt-% to 65 wt-% multiple-branched isoparaffins of the total weight of paraffins in the recycle stream. Typically, the recycle stream has a cloud point less than 0° C., preferably less than −5° C., more preferably less than −8° C., even more preferably less than −10° C., further preferably less than −20° C., further preferably less than −30° C. (ASTM D 5771-17). Typically, the recycle stream has a higher i-paraffin content and/or higher content of multiple multiple-branched i-paraffins than the HI effluent (total or degassed HI effluent), preferably expressed as wt-% i-paraffins or multiple-branched i-paraffins, respectively, based on the total weight of paraffins in the respective stream or effluent.

This kind of recycle streams have a particularly beneficial composition in view of degree of effective cracking in the hydrocracking, forming hydrocarbons boiling in the aviation fuel range, and also in gasoline boiling range, as generally paraffins are more prone to crack than cyclic hydrocarbons, longer paraffins are more prone to crack than shorter paraffins, and isoparaffins are foreseen more prone to crack than n-paraffins, and relative homogeneity of the recycle stream composition can make optimising the hydrocracking conditions in the second reactor easier. Additionally, these embodiments facilitate easy separation by mere splitting of e.g. diesel fuel component, marine fuel component, base oil component, and/or transformer oil component from the recycle stream, just to name a few examples of components that may be separated from such recycle streams.

Both the hydroisomerisation (HI) and hydrocracking (HC) catalysts may be arranged in one or more catalyst beds within the respective reactors. The HI catalyst and the HC catalyst may be arranged in at least one or more fixed bed(s), respectively. The HI catalyst may be any conventionally used HI catalyst and the HC catalyst may be any conventionally used HC catalyst. Preferably, the HI catalyst in the first reactor is a bifunctional HI catalyst, more preferably non-sulphided bifunctional HI catalyst. More preferably, the HI catalyst in the first reactor and the HC catalyst in the second reactor are bifunctional HI and HC catalysts respectively, more preferably non-sulphided bifunctional HI and HC catalysts, respectively.

Bifunctional HI and HC catalysts comprise metal sites for catalysing (de)hydrogenation reactions and acid sites for catalysing isomerisation and cracking reactions. Bifunctional HI catalysts and bifunctional HC catalysts are well known in the field of oil refining and in the field of renewable fuel production. Bifunctional HI and HC catalysts are preferred because they have excellent catalytic performance providing synergistic effects between the metal sites and acid sites. Bifunctional HI and HC catalysts are also beneficial as access and diffusion of molecules to catalytic sites may be controlled by suitably selecting porosity characteristics of the catalyst, especially pore size, pore dimension, and/or pore interconnectivity in the catalyst.

In certain particularly preferred embodiments, the HI catalyst is a non-sulphided bifunctional HI catalyst and the HC catalyst is a non-sulphided bifunctional HC catalyst, and said non-sulphided bifunctional catalysts comprise, independently from each other, at least one or more metals selected from noble metals of Group VIII of the Periodic Table, more preferably from Pt and/or Pd, and at least one or more acidic porous materials, and wherein the paraffinic hydrocarbon feed and the second reactor feed each comprises less than 50 wt-ppm, preferably less than 30 wt-ppm, more preferably less than 10 wt-ppm sulphur of the total respective feed (ppm by weight, calculated as elemental S), as determined according to ISO 20846-2019.

The sulphur content may be determined according to ISO 20846-2019 from liquids or according to ASTM D6667 from gaseous fractions.

Non-sulphided bifunctional catalysts are preferred because they do not require sulphidation during operation for maintaining their activity, and hence the sulphur content of various process streams may be kept low and less efficient H₂S separation and recovery is needed from various process streams. Especially non-sulphided bifunctional catalysts comprising noble-metals may be active at lower temperatures and show higher selectivity for isomerisation reactions, compared to sulphided catalysts, but are sensitive to deactivation by H₂S.

Preferably, the paraffinic hydrocarbon feed comprises sulphur less than 50 wt-ppm, preferably less than 30 wt-ppm, more preferably less than 10 wt-ppm (ppm by weight, calculated as elemental S), as determined according to ISO 20846-2019. Avery low sulphur content of the stream entering the first reactor is beneficial in that only very low amounts or essentially no H₂S is formed in the HI in the first reactor and hence present in the HI effluent.

In such embodiments, gas-liquid separation of the HI effluent, even if a portion thereof is to be incorporated into the second reactor feed, before feeding said portion to the second reactor, it is not necessary for protecting the HC catalyst in the second reactor, but gas-liquid separation of the HI effluent may nevertheless optionally be performed. The overall process may thus be simpler, and liquid transportation fuel component(s) with ultra-low sulphur content are obtainable. Furthermore, since less H₂S is present, also less corrosion is foreseen in the long-run, and potentially even less stringent corrosion resistance requirements could be applicable for some of the equipment materials.

Various different kinds of bifunctional HI and HC catalysts are commercially available, for example with different metals or metal combinations, different metal loadings, different acid strengths, and/or total acidities, and/or different porosities.

Bifunctional HC catalysts and bifunctional HI catalysts have similarities in the sense that both contain metal sites that are capable of catalysing (de)hydrogenation of n/i-paraffins to corresponding n/i-olefins, and acid sites that are capable of catalysing protonation of the n/i-olefins to n/i-carbocations, isomerisation of n-carbocations, or i-carbocations further, and/or cracking of n/i-carbocations into lighter n/i-olefin and lighter n/i-carbocation, and deprotonation of n/i-carbocations to n/i-olefins. Hydrogenation of the various n/i-olefins is catalysed again by the metal sites of these bifunctional catalysts to form n/i-paraffins. Whether isomerisation or cracking reactions prevail at given operating conditions and given feed composition, may be influenced especially by the characteristics of the bifunctional catalyst to be contacted with the feed. Such characteristics of the bifunctional catalyst include, for example, total acidity of the catalyst, number of Brønsted acid sites, strength and/or density of the acid sites, and content of the metal(s) in the catalyst.

Preferably, the bifunctional HI and HC catalysts comprise, independently from each other, at least one or more metals selected from Group VIII of the Periodic Table, preferably from noble metals of Group VIII, more preferably from Pt and/or Pd. Noble metals, particularly in the bifunctional HI catalyst, are preferred as they may provide higher selectivity towards isomerisation reactions under conditions of the first reactor, and are highly active at lower operating temperatures, compared to catalysts comprising only non-noble metals. High activity at lower temperatures provides a wider temperature range within which temperature may be adjusted, typically increased, during operation. Gradual catalyst deactivation occurring when the process is operated for longer time periods may be compensated to a certain extent by increasing temperature in the reactor.

Preferably, the bifunctional HI and HC catalysts comprise, independently from each other, at least one or more porous acidic materials having microporous, mesoporous, or hierarchical (micro-mesoporous) structure. Various zeolite-type materials such as SAPOs and zeolites are available providing desired acidity and porosity characteristics.

According to certain embodiments, the HI catalyst is a bifunctional HI catalyst, preferably a non-sulphided bifunctional HI catalyst, comprising
at least one or more metals selected from Group VIII of the Periodic Table, preferably from noble metals of Group VIII, more preferably from Pt and/or Pd; and
at least one or more acidic porous materials selected from zeolites and/or zeolite-type materials, wherein preferably at least one or more of the zeolites and/or zeolite-type materials has a framework type selected from AEL, ATO, AFO, MRE, MTT, MTW, TON, MRT, MOR, FER, and/or MWW, preferably at least one or more acidic porous materials selected from SAPO-11, SAPO-31, SAPO-41, ZSM-22, ZSM-23, ZSM-48, NU-10, ZBM-30, IZM-2, EU-2, and/or mordenite, more preferably at least one or more acidic porous materials selected from SAPO-11, SAPO-41, ZSM-23, and/or ZSM-48; and
optionally at least one or more of alumina, silica, amorphous silica-alumina, titanium alumina, titania, and/or zirconia.

This catalyst selection has been found to provide higher isomerisation selectivity in the first reactor that further contributes to achieving even higher amounts of isoparaffins, particularly multiple-branched isoparaffins, which can then be hydrocracked at lower temperature in the second reactor. The mentioned SAPOs and zeolites are commercially available with acidity and porosity characteristics that allow isomerisation, including multiple-branching, of n-paraffins, even of long-chained n-paraffins, such as C16+ paraffins.

Particularly for the hydrocracking reactions in the second reactor of the present process, bifunctional HC catalysts are beneficial because they have in addition to cracking activity also some isomerisation activity, and may be especially efficient in effective cracking. As further advantage, bifunctional HC catalysts comprising at least one or more metals selected from Group VIII noble metals, preferably from Pt and/or Pd have been found to provide at relatively low temperatures a high activity compared to HC catalysts comprising non-noble metals and thus even better control of thermal cracking. At low temperatures, the thermodynamic equilibrium tends to shift towards dearomatisation, thus reducing aromatics formation by side reactions. Providing the second reactor with a bifunctional HC catalyst may achieve an isoparaffin content (wt-% isoparaffins of the total weight of paraffins) in the recycle effluent that is not necessarily significantly lower than in the HI effluent, or may be the same or even higher.

Hence, according to certain embodiments, the hydrocracking catalyst is a bifunctional hydrocracking catalyst, preferably a non-sulphided bifunctional hydrocracking catalyst, comprising
at least one or more metals selected from Group VIII of the Periodic Table, Mo, Co and/or W, preferably from Ni, Mo, Co, W, Pt and/or Pd, more preferably from Pt and/or Pd; and
at least one or more acidic porous materials selected from zeolites, zeolite-type materials and/or amorphous silica-alumina, wherein preferably at least one or more of the zeolites or zeolite-type materials has a framework type selected from MFI, BEA, FAU, MOR, FER, AEL, AFI, ATO, AFO, MRE, MTT, MTW, TON, and/or MRT, preferably at least one or more acidic porous materials selected from SAPO-5, SAPO-11, SAPO-31, SAPO-41, ZSM-22, ZSM-23, ZSM-43, ZSM-48, IZM-2, mordenite, beta-zeolites, Y-type zeolites, and/or amorphous silica-alumina, more preferably at least one or more acidic porous material selected from SAPO-5, SAPO-11, ZSM-23, beta-zeolites, Y-type zeolites, and/or amorphous silica-alumina; and
optionally at least one or more of alumina, silica, titanium alumina, titania, and/or zirconia.

In certain embodiments, the HI catalyst in the first reactor and the HC catalyst in the second reactor have different acidity-related characteristics. The acidity-related characteristics of acidic porous materials, such as zeolite, may include nature, number, and distribution, according to relative strength, of acid sites, and may be determined by well-known methods, for example by adsorption-desorption methods where release of adsorbed base substance like ammonia or pyridine at higher temperature indicates presence of strong acid sites. As one example of usable adsorption-desorption methods, a temperature programmed desorption of ammonia can be mentioned, for examples as performed in accordance with the procedure described in Niwa et al (Niwa, M., Katada, N. Measurements of acidic property of zeolites by temperature programmed desorption of ammonia. Catalysis Surveys from Asia 1, 215-226 (1997)). Yet another well-known method for determining the acidic property of zeolites, including strength of acidity, is ¹H-NMR method, for examples as performed in accordance with the procedure described in Heeribout et al (Heeribout L., Semmer V., Batamack P., Dorémieux-Morin C., Fraissard J. Brønsted acid strength of zeolites studied by ¹H NMR: scaling, influence of defects. Microporous and Mesoporous Materials, Volume 21, Issues 4-6, May 1998, Pages 565-570). In certain embodiments, the bifunctional HC catalyst of the second reactor has a higher number of Brønsted acid sites compared to the bifunctional HI catalyst of the first reactor, as determined by NHs-TPD. In certain embodiments, the bifunctional HC catalyst has a higher total number of acid sites compared to the bifunctional HI catalyst, as determined by NH₃-TPD.

In certain preferred embodiments, the bifunctional HC catalyst of the second reactor has a higher content (wt-%) of Group VIII noble metal(s) compared to the bifunctional HI catalyst of the first reactor. In these embodiments as good or better yields of aviation fuel component were achieved at lower temperature, compared to otherwise similar process but using bifunctional HC catalyst that does not have a higher content of said noble metal(s) compared to the bifunctional HI catalyst.

In the present process, a paraffinic hydrocarbon feed is subjected to HI in the presence of a HI catalyst, and a second reactor feed comprising the recycle stream, and optionally a portion of the HI effluent are subjected to hydrocracking in the presence of a HC catalyst. The HI catalyst and the HC catalyst may have similar or same components. According to a preferred embodiment, the HI catalyst and the HC catalyst are different from each other. The HI catalyst and the HC catalyst may differ from each other for example by selection of at least one or more of a catalyst component, acidity, and/or metal loading, just to name a few, but it is also possible to use same catalyst as the HI catalyst in the first reactor and as the HC catalyst in the second reactor. Not merely the catalyst but also the operating conditions and the composition of the feed contribute to which reactions prevail. For example, when contacting the recycle stream with the HC catalyst under the hydrocracking conditions, more cracking may be expected compared to contacting the paraffinic hydrocarbon feed with the HI catalyst under the HI conditions, even if the catalysts were the same. Preferably, when contacting the paraffinic hydrocarbon feed with the HI catalyst under the HI conditions, isomerisation of this feed prevails over cracking, and when contacting the recycle stream (second reactor feed) with the HC catalyst under the hydrocracking conditions, cracking of this feed prevails over isomerisation.

The HI catalyst and the HC catalyst may be in ready-to-use state as such or they may be as treated in any customary way to adjust their properties, such as selectivity and/or activity, before or during start-up by subjecting to reduction, sulphidation, and/or passivation for example with a nitrogen containing compound, such as an amine or ammonia, so as to obtain the ready-to-use fresh or regenerated HI catalyst and/or HC catalyst. As used herein, HI catalyst, HC catalyst, fresh catalyst, and regenerated catalyst generally refer to the catalyst in its ready-to-use state.

In certain embodiments, the hydrocracking is followed by a further hydroisomerisation in the presence of a further hydroisomerisation catalyst. The further HI may be achieved for example by arranging the further HI catalyst in at least one separate bed in the second reactor, and/or in a subsequent third reactor.

The further HI catalyst may be a HI catalyst as has been described in the foregoing in connection with the HI catalyst in the first reactor. Preferably, the further HI catalyst is a bifunctional HI catalyst, more preferably a non-sulphided bifunctional HI catalyst. The HI catalyst in the first reactor, and the optional further HI catalyst in the second and/or third reactor may have different characteristics and/or composition, or may have same characteristics and compositions, i.e. they may be different catalysts or same catalysts. For process simplicity, it is preferred that the further HI catalyst is same catalyst as the HI catalyst. In those embodiments, it is preferred that the HC catalyst is different from the HI catalyst and the optional further HI catalyst.

It is well known to a skilled person how to select HI and hydrocracking conditions, preferably within the HI and hydrocracking condition ranges specified in the foregoing, taking into account the selected HI catalyst, composition of the paraffinic hydrocarbon feed, and targeted degree of isomerisation, as well as targeted content of multiple-branched isoparaffins in the HI effluent; and taking into account the selected hydrocracking (HC) catalyst, composition of the second reactor feed, targeted degree of effective cracking, targeted degree of isomerisation, as well as targeted content of multiple-branched isoparaffins in the effluent of the second reactor. To a certain extent, catalyst age or catalyst deactivation may also be taken into account when selecting or adjusting operating conditions of the first and/or the second reactor. During continued operation, the HI catalyst and the HC catalyst deactivate gradually for example due to impurities in process streams and coking. As the catalyst(s) deactivate, catalyst activity is reduced and selectivity affected, and at some point desired properties of the HI effluent and/or the recycle effluent are no longer reached. Also changes in the paraffinic hydrocarbon feed composition during the run may lead to deviation from the desired properties. When that happens, at least one or more operating conditions of the first reactor and/or the second reactor, including for example temperature, pressure, WHSV, and/or H₂ partial pressure at the inlet of the first reactor and/or the second reactor, may be adjusted, preferably within the operating condition ranges specified in the foregoing, to compensate for catalyst deactivation so that desired properties of the HI effluent and/or the recycle effluent may be reached again. Typically, this means increasing the temperature and/or decreasing the WHSV and/or adjusting the H₂ to paraffinic hydrocarbon feed ratio and/or increasing the pressure. However, there are limits beyond which e.g. the temperature cannot be increased and/or WHSV decreased without compromising yield and/or quality of the recovered liquid transportation fuel component(s).

For example, when operating temperature is increased to a high enough value, thermal cracking side reactions are increased, increasing the formation of gaseous hydrocarbons, and hence decreasing yield of liquid products. Accordingly, it is usually beneficial to start operating the HI reactor (first reactor) in the beginning of the run at a low temperature, using for example lowest feasible temperature in the specified range, as that provides the widest window for increasing the temperature upon gradual catalyst deactivation. Also, the HC catalyst deactivates gradually during continued operation, although typically at a lower pace compared to the HI catalyst, so similar considerations apply to adjusting operating conditions of the second reactor.

The active sites of the catalysts may be occupied and catalyst pores blocked by impurities and coke in the process streams, so that the sites are not available for catalysis anymore. For example, coke is caused by coke-forming compounds such as olefins, aromatics, and naphthenes, and coke formation may be enhanced by other impurities, when present in the paraffinic hydrocarbon feed. For impurities causing reversible catalyst deactivation it may be sufficient to monitor the total content of such impurity or impurities in the feed, as that may give indication of expected catalyst deactivation. For some other impurities, especially those causing irreversible catalyst deactivation, one may need to monitor the content of one or more of such impurities in the paraffinic hydrocarbon feed and calculate as the received value the cumulative amount thereof the HI catalyst has encountered at a given time point from the beginning of the run, and to compare the received value to a value that has been predetermined for example based on historical data, or a model based on historical data, to reflect too high catalyst deactivation so that meeting the target yield and/or quality of the desired fuel component(s) can no longer foreseen.

Preferably the present process comprises monitoring at least one or more parameters, typically indicative of deactivation of the HI and/or HC catalyst, to receive at least one or more values, comparing the received value(s) with predetermined value(s), and based on the comparison adjusting at least one or more operating conditions in the first reactor and/or in the second reactor, preferably within the operating conditions as specified in the foregoing for the hydroisomerisation and for the hydrocracking, respectively.

Hence, according to certain preferred embodiments, the process further comprises monitoring to receive at least one or more values at least one or more of the following parameters:
content of an impurity in the paraffinic hydrocarbon feed, preferably content of at least one or more of N, S, O, P, Si, Cl, Fe, alkali metals, alkaline earth metals, and/or coke-forming compounds in the paraffinic hydrocarbon feed; Said species or impurities are known catalyst deactivators, particularly deactivators of non-sulphided bifunctional HI catalysts comprising noble metal(s). Also, said species or impurities are commonly present in varying amounts in feeds derived from vegetable oils, animal fats, microbial oils, thermally and/or enzymatically liquefied organic waste and residues, as well as in feeds derived from Fischer-Tropsch process, and may hence in certain embodiments be carried-over in varying amounts to and be present in the paraffinic hydrocarbon feed. Typically, the elemental impurities are not present as such in the paraffinic feed, but contents thereof indicate presence of compounds comprising said impurities. Elemental impurities and coke-forming compounds are determined by standard laboratory analyses. Increased content of any of these impurities may lead to increased catalyst deactivation.
content of NH₃ and/or H₂S in the gaseous phase of the hydroisomerisation effluent and/or NH₃ and/or H₂S in the gaseous phase of the recycle effluent; In some cases, increased content of NH₃ and/or H₂S in the gaseous phase of the HI effluent could indicate increased catalyst exposure to said impurities. Increased content of any of these impurities may lead to increased catalyst deactivation.
physico-chemical characteristics of the hydroisomerisation effluent and/or of the recycle effluent, preferably at least one or more of a cloud point, freezing point, pour point, cold filter plugging point, kinematic viscosity, density, and/or a distillation characteristic; Increase in any of cloud point, freezing point, pour point, cold filter plugging point, kinematic viscosity, and/or density may indicate increased catalyst deactivation. Distillation characteristics, wherein an increase may be indicative of catalyst deactivation comprise T5, T50, FBP etc. As to further distillation characteristics, a shift of boiling point distribution to higher boiling compounds, may be indicative of catalyst deactivation. To some extent the physico-chemical characteristics may be indicative of or correlate with the content of isoparaffins or multiple-branched isoparaffins in the HI effluent and/or in the recycle effluent.
compositional characteristics of the hydroisomerisation effluent and/or of the recycle effluent, preferably at least one or more of content of isoparaffins, content of C8-C14 hydrocarbons, content of multiple-branched isoparaffins, and/or content of C1-C4 hydrocarbons in the hydroisomerisation effluent and/or the recycle effluent; Decrease in content of isoparaffins, multiple-branched isoparaffins, and/or C8-C14 hydrocarbons may indicate increased catalyst deactivation. To some extent the content of isoparaffins or multiple-branched isoparaffins may be indicative of or correlate with the physico-chemical characteristics of the HI effluent and/or of the recycle effluent. Content of C1-C4 hydrocarbons decreases along with increased catalyst deactivation. However, increasing operating temperature to compensate catalyst deactivation may lead to increase in C1-C4 hydrocarbon content.
yield of at least one or more of the recovered liquid transportation fuel components and/or of the separated recycle stream, preferably yield of the preferably recovered aviation fuel component; Increased yield of higher boiling hydrocarbons and increased volume of the separated recycle stream may indicate increased catalyst deactivation.
physico-chemical characteristics of at least one or more of the recovered liquid transportation fuel components and/or the separated recycle stream, preferably at least one or more of a cloud point, freezing point, pour point, cold filter plugging point, kinematic viscosity, density, research octane number (RON), cetane number, and/or a distillation characteristic; A decrease in cetane may indicate increased catalyst deactivation. Among distillation characteristics, an increase e.g. in T5, T50, T95, and/or FBP, or a shift of boiling point distribution to higher boiling compounds, may be indicative of catalyst deactivation. To some extent the physico-chemical characteristics may be indicative of or correlate with the content of isoparaffins or multiple-branched isoparaffins in the recovered liquid transportation fuel component(s) and/or the separated recycle stream.
compositional characteristics of at least one or more of the recovered liquid transportation fuel components and/or the separated recycle stream, preferably content of isoparaffins and/or content of multiple-branched isoparaffins in the recovered fuel component(s) and/or in the separated recycle stream; Decrease in content of isoparaffins, multiple-branched isoparaffins and C8-C14 hydrocarbons may indicate increased catalyst deactivation. To some extent the content of isoparaffins or multiple-branched isoparaffins may be indicative of, or correlate with, the physico-chemical characteristics of the recovered liquid transportation fuel components and/or the separated recycle stream.
and/or temperature difference over the first reactor or a catalyst bed therein and/or over the second reactor or a catalyst bed therein; Said temperature differences are relatively easy to monitor, and a decrease of the temperature difference may be a typical sign of catalyst deactivation.

comparing the received value(s) with predetermined value(s) and, based on the comparison, adjusting at least one or more operating conditions in the first reactor and/or in the second reactor, preferably adjusting at least one or more of temperature, pressure, weight hourly space velocity (WHSV), H₂ to paraffinic hydrocarbon feed ratio, H₂ to second reactor feed ratio, and/or H₂ partial pressure at the inlet of the first reactor and/or the second reactor, respectively, more preferably increasing the temperature and/or the pressure in the first reactor and/or in the second reactor, and/or decreasing the WHSV in the first reactor and/or in the second reactor.

Different parameters may be monitored and/or different predetermined values selected during the process, for example depending on changes in the targeted products and qualities.

In certain preferred embodiments, the process comprises monitoring at least two, or at least three of the above-mentioned parameters, typically indicative of deactivation of the HI and/or HC catalyst. For example, good cold properties (e.g. cloud point, pour point, and/or subzero viscosity) of the HI effluent may be achieved due to increased amount of shorter carbon chains caused by increased cracking taking place in the first reactor (caused e.g. by increased temperature), instead of sufficient degree of isomerization. Thus, it may be beneficial to monitor at least two or three or even more parameters in order to obtain better understanding on the status of the catalyst deactivation.

The monitoring may be performed continuously, repeatedly, continually, periodically, intermittently, discontinuously, or be one-time monitoring. The monitoring may be performed on-line, for example using a sensor or sensors in any of the process streams, feed tanks and/or product tanks, including slip-stream arrangements, or off-line, based on samples taken from any of the process streams, feed tanks, and/or product tanks. The frequency and way of monitoring of the one or more parameters may be performed independently from other monitored parameters, i.e. certain parameters may for example be monitored continuously on-line, while others may for example be monitored periodically off-line.

The monitoring may be discontinuous or one-time monitoring, especially in embodiments wherein the adjustment of one or more operating conditions of the first reactor and/or the second reactor is done based on historical process data, such as a model based on historical process data. For example, the content of one or more known catalyst deactivating impurities could be determined from a sample from each of the fresh feed tanks to be used in the process, and a temperature increase profile based on the determined contents of the one or more impurity could be programmed for the first reactor based on historical process data. The adjustment of operating conditions to obtain or maintain desired properties and/or yields of the HI effluent, the recycle effluent, the separated recycle stream, and/or the recovered liquid fuel component(s) may thus be done for example based on historical process data e.g. from earlier processes run using similar feed and similar qualitative and quantitative expectations for the recovered liquid transportation fuel components, and/or a model, e.g. a theoretical model or a model based on historical process data, and the received value(s) obtained for the monitored parameter(s) exemplified in the foregoing.

Once the operating conditions in the first and/or in the second reactor have been adjusted to their feasible extremes, preferably within the hydroisomerisation or hydrocracking condition ranges, respectively, specified in the foregoing, the catalyst(s) need to be changed to fresh one(s) or regenerated, in order to reach the targeted levels of degree of isomerisation and/or effective cracking again. As explained in the foregoing, the present process allows to improve the catalyst lifetime, i.e. to prolong catalyst change/regeneration intervals, and/or to use of feedstocks with heavier impurity load.

The present process comprises fractionation in which at least one or more liquid transportation fuel components are recovered and the recycle stream is separated. The amount of recycle stream separated and the amount of recycle stream fed to the second reactor may vary within broad ranges. Further liquid streams or cuts, such as side cut(s), may optionally be separated and/or recovered in the fractionation and optionally recycled back to the process.

Preferably, the recycle effluent and the HI effluent are fed to the fractionation in a weight ratio from 1:10 to 10:1, preferably from 1:5 to 5:1. Preferably, said ratios are recycle effluent to HI effluent. Ratios of recycle effluent to HI effluent towards the lower limits may be preferred when processing paraffinic hydrocarbon feeds boiling at lower temperatures, and ratios towards the upper limits may be preferred when processing paraffinic hydrocarbon feeds boiling at higher temperatures, such as paraffinic feeds comprising paraffins heavier than C18.

The fractionation of the present process may comprise any conventionally used fractionation technology. Preferably, the fractionation comprises distillation, such as atmospheric distillation or vacuum distillation, optionally preceded by a gas-liquid separation e.g. as described hereinafter. The fractionation may be carried out in a fractionation system comprising one or more fractionation units. For example, gases and light naphtha may be separated in a pre-fractionation unit, while the liquid transportation fuel component(s) and the recycle stream are recovered and separated from a main distillation unit downstream of the pre-fractionation unit. In an alternative example, a single fractionation unit may be used.

As mentioned, the recycle effluent and/or the HI effluent may be subjected to gas-liquid separation, as combined or independently from each other. The gas-liquid separation may be conducted for example as an integral step within the respective reactor, or within the fractionation system. Typically, the gas-liquid separation is conducted at a temperature within a range from 0° C. to 500° C., such as from 15° C. to 300° C., or from 15° C. to 150° C., preferably from 15° C. to 65° C., such as from 20° C. to 60° C., and preferably at the same pressure as that of the reactor wherefrom the effluent originates. Typically, the pressure during the gas-liquid separation(s) may be within a range from 0.1 MPa to 20 MPa, preferably from 1 MPa to 10 MPa, or from 3 MPa to 7 MPa.

According to certain embodiments of the present process, different products as liquid transportation fuel components may be recovered from the fractionation depending e.g. on the operating conditions chosen, composition of the used paraffinic feed, and/or market demand at a given time.

The liquid transportation fuel component(s) and optional further products separated and/or recovered from the fractionation may for example include gasoline fuel component(s) boiling within a range from about 25° C. to about 200° C., aviation fuel component(s) boiling within a range from about 100° C. to about 300° C., such from about 150° C. to about 300° C., a recycle stream having a T5 temperature of at least 270° C., diesel fuel component(s) boiling within a range from about 160° C. to about 380° C., and/or marine fuel component(s) boiling within a range from about 180° C. to about 600° C., such as from about 180° C. to about 400° C. (boiling within the ranges as determined according to EN ISO 3405-2019). In certain embodiments, gasoline fuel component(s) boiling within the range from about 25° C. to about 200° C., aviation fuel component(s) boiling within the range from about 100° C. to about 300° C., such from about 150° C. to about 300° C., and the recycle stream having a T5 temperature of at least 270° C. are first recovered and/or separated from the fractionation, and diesel fuel component(s) boiling within the range from about 160° C. to about 380° C. and/or marine fuel component(s) boiling within the range from about 180° C. to about 600° C. (boiling within the ranges as determined according to EN ISO 3405-2019), are recovered from the separated recycle stream. Further products may be recovered from the fractionation, such as split or further separated from the recycle stream. Examples of such further products include components for solvents, electrotechnical fluids, and base oils.

With the present process it is possible to produce an extremely low viscosity aviation fuel component, having a lower freezing point, and especially a lower kinematic viscosity at −20° C., compared to an aviation fuel component having similar IBP and FBP, but produced by conventional HDO of fatty feedstock followed by HI, i.e. without subjecting to hydrocracking as in the present process.

Hence, in preferred embodiments of the present process, at least one of the liquid transportation fuel components recovered from the fractionation is an aviation fuel component having density at 15° C. within a range from 730 to 772 kg/m3 (EN ISO 12185-1996), T10 temperature at most 205° C. (EN ISO 3405-2019), final boiling point at most 300° C. (EN ISO 3405-2019), flash point at least 38° C. (IP 170-2013, Abel closed-cup method), and freezing point at most −40° C. (IP 529-2016). In these embodiments the recovered aviation fuel component is of high quality, and can be incorporated in aviation fuel compositions in elevated amounts. Typically, the recovered aviation fuel component has T10 and T90 temperatures, as determined according to EN ISO 3405-2019, within a range from 120° C. to 295° C., preferably within a range from 130° C. to 295° C.

The present process enables recovery of at least an aviation fuel component in surprisingly high yields, even towards the end of the HI catalyst lifecycle. In preferred embodiments of the present process, the aviation fuel component is recovered in a yield of at least 30 wt-%, preferably at least 40 wt-%, more preferably at least 50 wt-%, such from 30 wt-% to 90 wt-% of the total weight of the paraffinic hydrocarbon feed. This is believed to be enabled by the high content of C8 to C14 hydrocarbons and isoparaffins in the feed subjected to fractionation, of which a notable share is multiple-branched isoparaffins. In certain preferred embodiments, the aviation fuel component has a difference between T90 and T10 temperatures, as determined according to EN ISO 3405-2019, at least 70° C., preferably at least 75° C., more preferably at least 80° C., even more preferably at least 85° C., typically at most 180° C., such as within a range from 80° C. to 150° C., preferably from 80° C. to 130° C. In these embodiments the aviation fuel component may be recovered with improved yields, while reaching the desired cold properties, density, and flash point characteristics. Poor quality of the total feed fed to the fractionation would necessitate limiting the FBP heavily in order to meet cold property requirements, which would limit also the T90 temperature and make the T90−T10 difference narrower. However, here the present process provides excellent characteristics including high isomerisation degree, particularly very high multiple-branched i-paraffin content, and modified distillation characteristics as the amounts of the carbon numbers are more evenly distributed, particularly in the C6-C18 range.

Typically, in the present process at least one or more of an aviation fuel component, a diesel fuel component, a gasoline fuel component, and/or a marine fuel component is recovered from the fractionation, preferably at least an aviation fuel component, more preferably at least an aviation fuel component and a diesel fuel component, even more preferably at least an aviation fuel component, a diesel fuel component, and a gasoline fuel component, are recovered from the fractionation. Generally, it is preferred to recover from the fractionation at least periodically at least one heavy product such as a diesel fuel component, marine fuel component, and/or a base oil component. In this way, the heaviest components can be removed from the recycle loop.

In certain preferred embodiments, the recovered liquid transportation fuel component(s) has/have a biogenic carbon content (EN 16640 (2017)) of at least 50 wt-%, preferably at least 70 wt-%, more preferably at least 90 wt-%, further preferably at least 95 wt-%, or even about 100 wt-%, based on the total weight of carbon (TC) in the respective recovered liquid transportation fuel component. The biogenic carbon content in the recovered liquid transportation fuel component(s) is mainly influenced by the biogenic carbon content in the paraffinic hydrocarbon feed, in preferred embodiments by the oxygenated hydrocarbon feed subjected to HDO. However, e.g. any amounts of fossil hydrocarbon diluent fed to the HDO reactor may affect the biogenic carbon content of the recovered liquid transportation fuel component(s).

Typically, the recovered liquid transportation fuel component(s) have improved (increased) isoparaffin content, particularly multiple-branched isoparaffin content, compared to corresponding component(s) obtained by conventional HDO of fatty feedstock followed by HI, i.e. without subjecting to hydrocracking as in the present process. A typical aviation fuel component recovered from the present process comprises C6-C18 i-paraffins at least 85 wt-%, preferably at least 87 wt-%, more preferably at least 90 wt-%, even more preferably at least 92 wt-% of the total aviation fuel component weight; and/or C6-C18 multiple-branched i-paraffins at least 58 wt-%, preferably at least 60 wt-%, more preferably at least 62 wt-% of the total aviation fuel component weight. A typical diesel fuel component recovered from the present process comprises C15-C22 i-paraffins at least 70 wt-%, preferably at least 75 wt-%, more preferably at least 80 wt-%, even more preferably at least 90 wt-% of the diesel fuel component weight; and/or C15-C22 multiple-branched i-paraffins at least 60 wt-%, preferably at least 63 wt-%, more preferably at least 65 wt-% of the diesel fuel component weight. A typical gasoline fuel component recovered from the present process comprises at least 50 wt-%, preferably at least 55 wt-%, more preferably at least 60 wt-%, even more preferably at least 65 wt-% C4-C9 i-paraffins of the gasoline fuel component weight; and/or at least 5 wt-%, preferably at least 6 wt-%, more preferably at least 7 wt-%, even more preferably at least 10 wt-%, or at least 11 wt-% C6-C9 multiple-branched i-paraffins of the gasoline fuel component weight.

Even if each of the gasoline fuel component, aviation fuel component, and diesel fuel component are recovered at the same time in the present process, they can be recovered as reasonably wide fractions. When the yield of the aviation fuel component is optimized, the diesel fuel component may be recovered as a narrower cut, or not at all.

As shown in the Examples, the products recovered from the process have excellent characteristics. The recovered liquid transportation fuel component(s) are suitable for use as blending components in fuel compositions, and may even be used, when suitably additized, as fuels as such, i.e. as unblended components. The recovered liquid transportation fuel component(s), and optional further products, are suitable for a wide range of various other uses, such as in feedstock(s) for industrial conversion processes, preferably in thermal cracking feedstock(s), such as in steam cracking feedstock(s), and/or in catalytic cracking feedstock(s), in transformer oil(s), in heat-transfer medium or media, in switchgear oil(s), in shock absorber oil(s), in insulating oil(s), in hydraulic fluid(s), in gear oil(s), in transmission fluid(s), in degreasing composition(s), in penetrating oil(s), in anticorrosion composition(s), in multipurpose oil(s), in metal working fluid(s), in rolling oil(s) especially for aluminium, in cutting oil(s), in drilling fluid(s), in solvent(s), in lubricant(s), in extender oil(s), in carrier(s), in dispersant composition(s), in demulsifier(s), in extractant(s), in paint composition(s), in coating fluid(s) or paste(s), in adhesive(s), in resin(s), in varnish(es), in printing paste(s) or ink(s), in detergent(s), in cleaner(s), in plasticizing oil(s), in turbine oil(s), in hydrophobization composition(s), in agriculture, in crop protection fluid(s), in construction, in concrete demoulding formulation(s), in electronic(s), in medical appliance(s), in composition(s) for car, electrical, textile, packaging, paper, cosmetic and/or pharmaceutical industry, and/or in manufacture of intermediate(s) therefor. The relatively high isomerisation degree and elevated share of shorter carbon chains are foreseen to improve fluidity, pumping and mixing characteristics and blendability of the recovered components and/or products. These are generally desired and beneficial properties for a wide range of uses, particularly involving spraying, injecting and/or admixing with other ingredients.

### Schematic Presentation of the Process

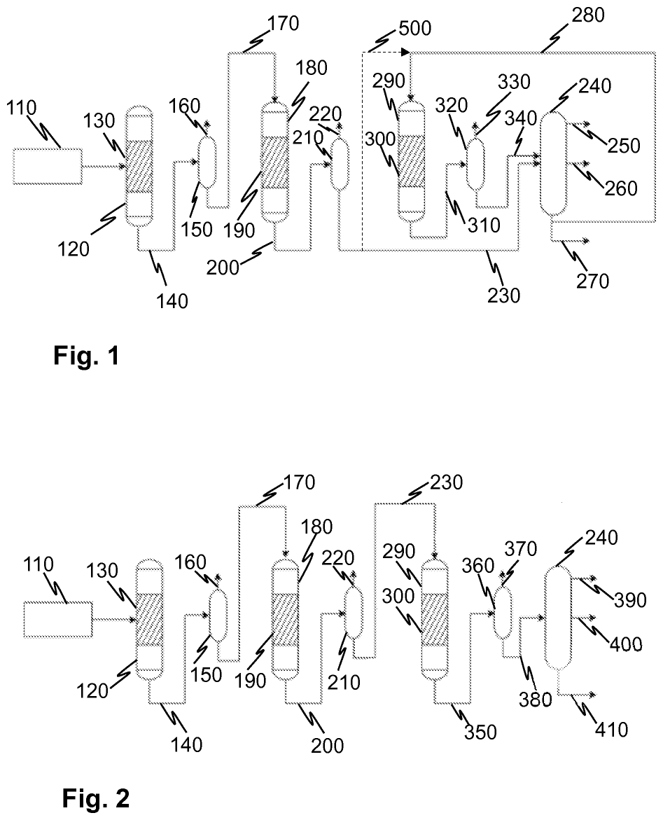

FIG. 1 schematically shows a process according to an example embodiment. In FIG. 1, oxygenated hydrocarbon feed 110 is fed to a HDO reactor 120 in which it is subjected to hydrodeoxygenation in the presence of a HDO catalyst 130 to obtain a hydrodeoxygenation effluent (HDO effluent) 140, and the obtained HDO effluent 140 is subjected to gas-liquid separation 150 to separate from the HDO effluent at least compounds that are gaseous at NTP 160 to obtain a degassed HDO effluent 170, which is in this example embodiment the herein defined paraffinic hydrocarbon feed. The degassed HDO effluent 170 is in FIG. 1 then fed to a first reactor 180 in which the degassed HDO effluent 170 is subjected to hydroisomerisation in the presence of a HI catalyst 190 to obtain a HI effluent 200 and the obtained HI effluent 200 is subjected to gas-liquid separation 210 to separate from the HI effluent 200 at least compounds that are gaseous at NTP 220 to obtain a degassed HI effluent 230. In FIG. 1, the degassed HI effluent 230 is fed to a distillation unit 240, that may comprise a single column, or prefractionation and main distillation columns, from which several streams or cuts are obtained. From the distillation in FIG. 1, a gasoline fuel component 250, an aviation fuel component 260, and/or a diesel fuel component 270 are recovered. Further, a recycle stream 280 having a T5 boiling point of 270° C. or higher is separated. The recycle stream 280 is in FIG. 1 fed to a second reactor 290 in which it is subjected to hydrocracking in the presence of a HC catalyst 300 to obtain a recycle effluent 310. In FIG. 1, the recycle effluent 310 is subjected to gas-liquid separation 320 to separate from the recycle effluent 310 at least compounds that are gaseous at NTP 330 to obtain a degassed recycle effluent 340, and the degassed recycle effluent 340 is then fed as a co-feed with the degassed HI effluent 230 to the distillation unit 240 for fractionation. In certain embodiments a portion of the HI effluent 200, 230 may be fed as a co-feed 500 with the recycle stream 280 to hydrocracking in the second reactor 290.

Without limitation to the example embodiment of FIG. 1, in certain preferred embodiments of the present process where at least an aviation fuel component is recovered from the fractionation and comprising monitoring parameters preferably indicative of deactivation of the HI catalyst, the monitored parameters include at least one or more of the following: temperature difference over the first reactor 180 or over a bed of HI catalyst 190, cloud point and/or pour point of the degassed HI effluent 230, cloud point and/or pour point of the recycle stream 280 or the diesel fuel component 270, freezing point and/or one or more distillation characteristics of the aviation fuel component 260, the corresponding received values of which are compared with predetermined values. When the monitored parameter is the cloud point of the degassed HI effluent 230, the predetermined value may be e.g. max. −5° C.; for the cloud point of the recycle stream 280 or the diesel fuel component 270 the predetermined value may be e.g. max. −15° C. (ASTM D 5771-17); for the freezing point of the aviation fuel component 260 the predetermined value may be e.g. max. −40° C. (IP 529-2016); for the distillation characteristics of the aviation fuel component 260 the predetermined value may be e.g. for T10 max. 205° C. or for T90−T10 difference e.g. min. 22° C. (EN ISO 3405-2019); for the distillation characteristics of the diesel fuel component 270 the predetermined value may be e.g. T95 max. 360° C. (EN ISO 3405-2019). Parameters indicative of deactivation of the HC catalyst may be monitored similarly, just referring to the second reactor 290 and bed of the HC catalyst 300 therein, and the degassed recycle effluent 340 therefrom. The received values may be compared with predetermined values, and based on the comparison at least one or more operating conditions in the first reactor and/or in the second reactor may be adjusted, preferably at least one or more of temperature, pressure, weight hourly space velocity (WHSV), H₂ to paraffinic hydrocarbon feed ratio, H₂ to second reactor feed ratio, and/or H₂ partial pressure at the inlet of the first reactor and/or the second reactor. After adjusting, the monitored parameters and the predetermined values may be kept unchanged, or different parameters may be monitored, and/or different predetermined values selected, depending e.g. on whether same products and qualities thereof are still targeted.

FIG. 2 schematically shows a comparative process that also involves a hydrocracking step. This process was used in Example 1, for the Comparative Example. In FIG. 2, oxygenated hydrocarbon feed 110 is fed to a HDO reactor 120 in which it is subjected to hydrodeoxygenation in the presence of a HDO catalyst 130 to obtain a hydrodeoxygenation effluent (HDO effluent) 140 and the obtained HDO effluent 140 is subjected to gas-liquid separation 150 to separate from the HDO effluent at least compounds that are gaseous at NTP 160 to obtain a degassed HDO effluent 170, which is in this comparative example paraffinic hydrocarbon feed as herein defined. The degassed HDO effluent 170 is in FIG. 2 then fed to a first reactor 180 in which the degassed HDO effluent 170 is subjected to hydroisomerisation in the presence of a HI catalyst 190 to obtain a HI effluent 200, and the obtained HI effluent 200 is subjected to gas-liquid separation 210 to separate from the HI effluent 200 at least compounds that are gaseous at NTP 220 to obtain a degassed HI effluent 230. In FIG. 2, the degassed HI effluent 230 is fed to a second reactor 290 in which it is subjected to hydrocracking in the presence of a HC catalyst 300 to obtain a hydrocracking effluent 350, and the hydrocracking effluent 350 is subjected to gas-liquid separation 360 to separate from the hydrocracking effluent 350 at least compounds that are gaseous at NTP 370 to obtain a degassed hydrocracking effluent 380. In FIG. 2, the degassed hydrocracking effluent 380 is fed to a distillation unit 240, that may comprise a single column, or prefractionation and main distillation columns, where it is fractionated into several streams or cuts. From the distillation in FIG. 2, a gasoline fuel component 390, an aviation fuel component 400, and a diesel fuel component 410 are recovered.

### EXAMPLES

### Example 1—Simulations

Simulations were carried out using Aspen Plus V10.0 software for illustrating benefits of the present process compared to a conventional HVO process where fatty feedstock is subjected to a hydrodeoxygenation (HDO) step and subsequent hydroisomerisation (HI) step, as disclosed e.g. in F1100248 and EP1396531, followed by fractionation to recover at least an aviation fuel component.

The oxygenated hydrocarbon feed fed to HDO comprised 100% animal fat, and the highly paraffinic hydrocarbon feed (comprising about 98 wt-% paraffins) fed to HI comprised about 59 wt-% C17-18 n-paraffins, about 29 wt-% C15-16 n-paraffins, about 4 wt-% C17-18 isoparaffins, and about 2 wt-% C15-16 isoparaffins. About 97 wt-% of the paraffinic hydrocarbon feed fed to HI was C14-C22 hydrocarbons, and about 1 wt-% was cyclic hydrocarbons.

Reference 1 (Tables 1 and 2) shows a typical product distribution recovered from fractionation of a conventional HVO process run in winter grade renewable diesel production mode, i.e. involving a HDO step followed by a medium severity HI step.

Reference 2 (Tables 1 and 2) shows a typical product distribution recovered from fractionation of a HVO process run with a similar HDO step than Reference 1 but followed by a high severity HI step using a fresh catalyst.

For the INV (Tables 1 and 2), the process presented in FIG. 1 was used, with HDO and HI steps run similarly as for Reference 1, followed by fractionating the HI effluent and a recycle effluent coming from hydrocracking reactor fed with a recycle stream (portion of the diesel component recovered from the fractionation). For the Comparative Example (Tables 1 and 2), the process presented in FIG. 2 was used, with HDO and HI steps run similarly as for Reference 1, followed by hydrocracking of the HI effluent, and fractionation.

Components shown in Table 1 were recovered from fractionation. Tables 1 and 2 show that compared to the process of Reference 2 and of the Comparative Example, the process of INV provided remarkably increased yield of high quality sustainable/renewable aviation fuel (SAF) component (71.6 wt-%), without sacrificing total yield of the liquid products, or properties of other liquid products. Additionally, almost five times higher gasoline component yield was achieved with the process of the INV. As a significant benefit over the process of Reference 2, the yield and product quality improvements were achieved while avoiding limitations of the process of Reference 2, i.e. without the need to use high severity HI, typically involving inter alia elevated temperature and/or lower WHSV compared to medium-severity HI conditions, and/or use of a fresh HI catalyst. Product properties achieved by the process of the INV are on a similar high level as achieved by the Comparative Example, the aviation fuel component obtained by the INV having slightly better (lower) kinematic viscosity at −40° C.

TABLE 1
Results from the simulation tests, yields based
on raw material feed (oxygenated hydrocarbons).

| | Winter | | | | |
|---|---|---|---|---|---|
| | Grade | Aviation | Gasoline | Light | |
| | Diesel fuel | fuel | fuel | gaseous | Recycled |
| | component | component | component | components | Diesel |
| | (wt-%) | (wt-%) | (wt-%) | (wt-%) | (wt-%) |
| Reference 1 | 80.0 | 0 | 3.5 | 1.6 | — |
| Reference 2 | 17.1 | 64.2 | 0.4 | 3.4 | — |
| INV | 7.9 | 71.6 | 1.9 | 3.8 | 62.0 |
| Comparative | 15.9 | 65.5 | 0.4 | 3.3 | 0 |
| Example | | | | | |

TABLE 2
Product properties. SAF denotes sustainable/renewable aviation fuel component.

| | Cloud point | | | | Final | Viscosity |
|---|---|---|---|---|---|---|
| | of Winter | Freezing | | | boiling | of SAF at |
| | Grade | point of | Density | Flash | point | −40° C. |
| | Diesel fuel | SAF | of SAF | point of | ASTM | (mm²/s), |
| | (° C.), | (° C.), IP | (kg/m³), | SAF | D86 of | EN ISO |
| | ASTM | 529- | ENISO | (° C.), IP | SAF | 3104- |
| | D7689-17 | 2016 | 12185 | 170 | (° C.) | 2020 |
| Reference 1 | −34.3 | — | — | — | — | — |
| Reference 2 | −34.0 | −47.2 | 771.9 | 38.0 | 300.0 | 26.0 |
| INV | −34.2 | −56.6 | 770.7 | 38.0 | 300.0 | 24.7 |
| Comparative | −37.7 | −59.3 | 772.0 | 38.0 | 295.2 | 26.3 |
| Example | | | | | | |

### Example 2—Test Runs

### 2.1 Production of Liquid Transportation Fuel Components

Oxygenated hydrocarbon feedstocks containing animal fats and vegetable oils were first pre-treated to remove impurities using a conventional bleaching protocol. The bleached oxygenated hydrocarbon feedstocks were subjected to hydrodeoxygenation at about 320° C., about 50 bar, using sulphided NiMo on alumina catalyst with WHSV of between 0.3-1 1/h and hydrogen flow between 500 and 1000 NI/I feed. Gases and water were separated and discarded from the liquid streams to obtain the paraffinic hydrocarbon feeds. Typical exemplary composition of such paraffinic hydrocarbon feed originating from a mixture of animal fats and vegetable oils is, based on total paraffinic hydrocarbon feed weight: paraffins about 99 wt-%, total isoparaffins about 9 wt-%, multiple-branched isoparaffins about 2 wt-%, n-paraffins about 90 wt-%, sum amount of other than paraffins (e.g. cyclic hydrocarbons, olefins) about 1 wt-%, sum amount of C12-C30 hydrocarbons about 99 wt-%, sum amount of C14-C20 hydrocarbons about 98 wt-%.

The obtained paraffinic hydrocarbon feeds were subjected to a hydroisomerisation in the presence of a non-sulphided bifunctional hydroisomerisation catalyst (Pt/SAPO). Conditions in the HI reactor were of low severity for obtaining Stream 1 and of high severity for obtaining Stream 2. The HI effluents were subjected to gas-liquid separation (degassing) and stabilisation, thereby removing gases, and recovering light naphtha fraction (first pass gasoline fuel component), to obtain Stream 1 and Stream 2. The fractionation was continued by recovering from the stabilised streams, Stream 1, and Stream 2 respectively, a (first pass) aviation fuel component and a heavy bottom as the recycle stream, usable as a (first pass) diesel fuel component. Properties of the various streams and products are presented in Table 3.

TABLE 3
HI conditions, yields and properties of the degassed and stabilized HI effluents Stream 1
and Stream 2, as well as of first pass gasoline fuel component, first pass aviation fuel
component, and Recycle Stream 1 and Recycle Stream 2 (first pass diesel fuel component).
Degassed and stabilised HI effluent properties

| | | | Stream 2 | |
|---|---|---|---|---|
| | Stream 1 | | Animal fat/vegetable oil base | |
| | Animal fat/vegetable oil base | | subjected to HDO, high | |
| | subjected to HDO, low severity | | severity HI, degassing, and | |
| | HI, degassing, and recovery of | | recovery of bottom fraction as | |
| | bottom fraction as HC feed | | HC feed | |
| Cloud point (ASTM | −16° | C. | −45° | C. |
| D7689-17) | | | | |
| Density at 15° C. | 781 | kg/m³ | 774 | kg/m³ |
| (ENISO12185) | | | | |

| | | |
|---|---|---|
| IBP to FBP (ENISO3405- | 218° C. to 307° C. | 124° C. to 308° C. |
| 2019) | | |
| T10 to T90 (ENISO3405- | 275° C. to 296° C. | 210° C. to 289° C. |
| 2019) | | |
| Composition (GC × GC-FID/ | nP: 14.5 wt-%; total iP: 85.2 | nP: 7.0 wt-%; total iP: 94.2 |
| GC × GC-MS) | wt-%; multi-iP: 20.3 wt-% | wt-%; multi-iP: 55.7 wt-% |

First pass gasoline fuel component

| | | |
|---|---|---|
| Yield based on | 2 wt-% | 3 wt-% |
| oxygenated hydrocarbons | | |

| | |
|---|---|
| Properties of a typical 1^{st} | Boiling within ~50-170° C. (ENISO3405) |
| pass gasoline fuel | nP: ~40 wt-%; total iP: ~50 wt-%; multi-iP <5 wt-% |
| component | (GC-FID/GC-MS) |

First pass aviation fuel component

| | | |
|---|---|---|
| Yield based on degassed | 27 wt-% | 76 wt-% |
| HI effluent | | |
| IBP to FBP (ENISO3405- | 160° C. to 270° C. | 140° C. to 290° C. |
| 2019) | | |

Recycle stream (first pass diesel fuel component)

| | Recycle Stream 1 | | Recycle Stream 2 | |
|---|---|---|---|---|
| Yield based on degassed | 71 | wt-% | 22 | wt-% |
| HI effluent | | | | |
| Cloud point (ASTMD7689- | −11° | C. | −30° | C. |
| 17) | | | | |
| Density at 15° C. | 786 | kg/m³ | 788 | kg/m³ |
| (ENISO12185-1996) | | | | |
| Aromatics (EN12916) | 0.3 | wt-% | 0.6 | wt-% |

| | | |
|---|---|---|
| IBP to FBP (ENISO3405- | 286° C. to 317° C. | 284° C. to 327° C. |
| 2019) | | |
| T5; T10 to T90 | 294° C.; 295° C. to 301° C. | 292° C.; 293° C. to 300° C. |
| (ENISO3405-2019) | | |
| Paraffins, wt-% (GC × GC- | nP: 13 wt-%, total iP: 87 wt-%, | nP: 3 wt-%, total iP: 97 wt-%, |
| FID/GC × GC-MS) | multi-iP: 23 wt-%; C15-C18 | multi-iP: 64 wt-%; C15-C18 |
| | (each present): 96 wt-% in total | (each present): 94 wt-% in total |

The properties of Recycle Stream 1 would allow its use as a diesel fuel component e.g. in summer diesel, while the properties of the Recycle Stream 2 would allow its use as a diesel fuel component e.g. in winter diesel grades.

A portion of the Recycle Stream 1 and of the Recycle Stream 2 was subjected to hydrocracking using a non-sulphided bifunctional noble metal catalyst on acidic material. The temperature in the hydrocracking step was varied so that it was lower, similar, or higher than in the hydroisomerisation. The hydrocracking conditions, properties of total liquid product (i.e. of the recycle effluent as degassed) collected from hydrocracking as well as yield of the total liquid product (as wt-% of the second reactor feed including H₂) are presented in Table 4. Compositional characteristics of hydrocracking products (degassed recycle effluents) are presented in Table 5.

TABLE 4
Liquid yields (wt-% of the second reactor feed including H₂) as well as
cloud points and densities of the degassed recycle effluents (total liquid products)
from test runs conducted using different conditions, indicating also
whether temperature at hydrocracking was higher, lower or about the same as at
the respective HI (T(HI)). H₂ to second
reactor feed ratio was 300 nL/L in all experiments.

| | | | | | | Cloud point, | Density at | |
|---|---|---|---|---|---|---|---|---|
| | | | T at HC | | | ° C. | 15° C., kg/m³ | Liquid |
| Test | | T | compared | p | WHSV | (ASTM | (ENISO | yield, |
| Run | Feed | (° C.) | to T(HI) | (bar) | (1/h) | D7689-17) | 12185-1996) | wt-% |
| TR1 | Recycle | 332 | T < T(HI) | 30 | 1.3 | −45 | 782 | 94.8 |
| | stream 2 | | | | | | | |
| TR2 | Recycle | 332 | T < T(HI) | 20 | 1.3 | −48 | 780 | 92.4 |
| | stream 2 | | | | | | | |
| TR3 | Recycle | 352 | T > T(HI) | 20 | 1.3 | −72 | 765 | 86.0 |
| | stream 2 | | | | | | | |
| TR4 | Recycle | 332 | T < T(HI) | 40 | 1.3 | −43 | 784 | 93.4 |
| | stream 2 | | | | | | | |
| TR5 | Recycle | 352 | T > T(HI) | 40 | 1.3 | −65 | 771 | 92.1 |
| | stream 2 | | | | | | | |
| TR8 | Recycle | 348 | T > T(HI) | 40 | 0.8 | −79 | 747 | 95.5 |
| | stream 2 | | | | | | | |
| TR9 | Recycle | 324 | T < T(HI) | 40 | 0.8 | −46 | 777 | 95.1 |
| | stream 2 | | | | | | | |
| TR12 | Recycle | 348 | T > T(HI) | 60 | 0.8 | −74 | 753 | 95.5 |
| | stream 2 | | | | | | | |
| TR14 | Recycle | 309 | T < T(HI) | 40 | 0.8 | −41 | 784 | 96.5 |
| | stream 1 | | | | | | | |
| TR15 | Recycle | 348 | T > T(HI) | 40 | 0.8 | −78 | 736 | 95.4 |
| | stream 1 | | | | | | | |
| TR16 | Recycle | 324 | T~T(HI) | 40 | 0.8 | −45 | 771 | 96.3 |
| | stream 1 | | | | | | | |

From Table 4 it can be seen that the liquid yields were high in each of the test runs in Table 4, higher HC temperatures having a slightly reducing effect on liquid yield. Additionally, each of the recycle effluents recovered from the test runs had remarkably reduced cloud points, and reduced densities, compared to the respective recycle stream. In recycle effluents originating from recycle stream 1 having higher cloud point to start with (than recycle stream 2), the decrease in cloud points was more dramatic.

TABLE 5
Compositional analysis of the degassed recycle effluents (of
total liquid products) as determined by GCxGC-FID/GCxGC-MS.

| | | mono | multi | | | |
|---|---|---|---|---|---|---|
| Test | n-paraffins | i-paraffins | i-paraffins | Naphthenes | Aromatics | C15-C18 |
| Run | (wt-%) | (wt-%) | (wt-%) | (wt-%) | (wt-%) | (wt-%) |
| TR1 | na | na | na | na | na | |
| TR2 | 4.0 | 19.2 | 75.4 | 1.4 | 0.1 | |
| TR3 | 8.4 | 25.3 | 63.5 | 1.8 | 0.9 | |
| TR4 | 3.3 | 19.3 | 76.3 | 1.1 | 0.0 | |
| TR5 | na | na | na | na | na | |
| TR8 | 9.7 | 31.5 | 56.9 | 1.7 | 0.1 | 46 |
| TR9 | 4.7 | 18.9 | 75.0 | 1.0 | 0.0 | 79 |
| TR12 | 9.1 | 28.9 | 60.4 | 1.4 | 0.0 | 52 |
| TR14 | 2.7 | 16.6 | 79.3 | 1.0 | 0.0 | 89 |
| TR15 | 12.8 | 34.9 | 50.7 | 1.2 | 0.4 | 38 |
| TR16 | 4.7 | 22.7 | 71.6 | 0.9 | 0.0 | 79 |

From Table 5 it can be seen that each of the recycle effluents originating from Recycle Stream 1 had efficiently reduced C15-C18 hydrocarbons contents, reduced n-paraffin contents, and greatly increased multiple-branched i-paraffin contents, compared to Recycle Stream 1. Aromatics content in these recycle effluents was at most same (at the highest HC temperature) or lower than that of Recycle Stream 1, indicating dearomatisation at the lower HC temperatures. Each of the recycle effluents originating from Recycle Stream 2 for which C15-C18 content was determined had efficiently reduced C15-C18 contents compared to Recycle Stream 2. Each of the recycle effluents originating from Recycle Stream 2 for which n-paraffin content was determined had slightly increased n-paraffin contents compared to Recycle Stream 2. Most of the recycle effluents originating from Recycle Stream 2 had increased multiple-branched i-paraffin contents compared to Recycle Stream 2. Just the recycle effluents from test runs using highest HC temperatures had slightly reduced multiple-branched i-paraffin contents compared to Recycle Stream 2. Aromatics content in the recycle effluents originating from Recycle Stream 2 was reduced indicating efficient dearomatisation occurring during the HC, except in the test run 3 involving HC at highest temperature (352° C.), where the aromatics content increased slightly, most likely due to the combination of high T and low pressure. In summary, these results show that hydrocracking of the recycle streams at various hydrocracking conditions decreased the C15-C18 content from ˜95 wt-% to less than 90%, even below 40 wt-%, and that the hydrocracking did not just crack mono-iP molecules to one n-paraffin and one isoparaffin, but efficiently increased the isomerisation degree in terms of contents of multiple-branched i-paraffins. The effect can be deduced also from the physico-chemical characteristics of the recycle effluents reported in Table 4: density and especially cloud point of the recycle effluents are lower than those of the respective recycle streams.

Yields of recoverable C1-C4 gases, C5+ gases, and gasoline, aviation and diesel fuel components were calculated from simdis analysis of the recycle effluents, and are reported in Table 6.

TABLE 6
Product yields (wt-% of the second reactor feed including
H₂) based on gas analysis and analysis of liquid product
(simulated distillation ASTM D2887-19e1).

| | C1-C4 | C5+ | | | |
|---|---|---|---|---|---|
| Test | gases | gases | <150° C. | 150-300° C. | >300° C. |
| Run | (wt-%) | (wt-%) | (liq.)(wt-%) | (liq.)(wt-%) | (liq.)(wt-%) |
| TR1 | 1.1 | 0.8 | 3.2 | 41.4 | 50.3 |
| TR2 | 2.0 | 1.4 | 4.2 | 45.1 | 43.1 |
| TR3 | 6.3 | 3.8 | 12.8 | 50.9 | 22.4 |
| TR4 | 1.5 | 0.9 | 3.1 | 36.8 | 53.6 |
| TR5 | 3.2 | 1.9 | 9.1 | 51.0 | 31.9 |
| TR8 | 1.4 | 0.3 | 19.6 | 58.0 | 17.9 |
| TR9 | 1.5 | 0.3 | 5.2 | 42.0 | 47.8 |
| TR12 | 1.1 | 0.2 | 18.9 | 55.1 | 21.5 |
| TR14 | 0.2 | 0.0 | 2.1 | 34.2 | 60.2 |
| TR15 | 1.6 | 0.3 | 26.4 | 58.9 | 10.1 |
| TR16 | 0.4 | 0.1 | 6.6 | 47.0 | 42.7 |

Liq. denotes liquid.

From Table 6 it can be seen that lower hydrocracking temperatures provided a bit higher liquid yields than higher hydrocracking temperatures. Generally, the 150-300° C. fraction yields (i.e. aviation fuel boiling range) were at good level, particularly when using lower WHSV. Increasing WHSV seemed to decrease 150-300° C. fraction yield but only a bit, while in IBP-150° C. fraction yield a more pronounced decrease was seen and at the same time 300° C.-FBP fraction yield increased. Surprisingly, C1-C4 yields remained low even when hydrocracking the highly isomerised and multi-branched Recycle Stream 2. Gaseous yield was elevated only in test run 3 involving HC at highest temperature (352° C.) combined with lowest pressure (20 bar). Thus, adjusting the hydrocracking operating conditions seems to provide a convenient way to adjust the yields of the different liquid transportation fuel components, e.g. depending on the market need.

### 2.2 Properties of Recovered Liquid Transportation Fuel Components

Recycle effluents from the hydrocracking test runs were subjected to fractionation to recover a gasoline fuel component, an aviation fuel component, and a diesel fuel component. Additionally for one of the recycle effluents, the fractionation was conducted in an optimised way so as to increase the aviation fuel component yield (test run 8 with optimised fractionation, TR8o). Some product properties are reported in Table 7.

TABLE 7
Distillation characteristics of the gasoline, aviation and diesel fuel
components recovered from recycle effluents of selected test runs.
Yields are presented as wt-% of the degassed recycle effluent.

| | TR8 | | | TR15 | | | TR8o | | |
|---|---|---|---|---|---|---|---|---|---|
| | Gasol. | SAF | Diesel | Gasol. | SAF | Diesel | Gasol. | SAF | Diesel |
| | ASTM | EN ISO | ASTM | ASTM | EN ISO | ASTM | ASTM | ASTM | ASTM |
| | D7096 | 3405 | D2887 | D7096 | 3405 | D2887 | D7096 | D7345 | D2887 |
| Yield, | 25 | 57 | 17 | 30 | 55 | 15 | 11 | 64 | 17 |
| wt-% | | | | | | | | | |
| IBP, ° C. | −42 | 176 | 291 | −44 | 159 | 291 | −0.9 | 148 | 289 |
| T5, ° C. | −0.8 | 193 | 296 | −42 | 172 | 295 | 28 | 165 | 295 |
| T10, ° C. | 27 | 200 | 298 | −13 | 177 | 296 | 28 | 169 | 296 |
| T20, ° C. | 36 | 215 | 300 | −1.1 | 187 | 298 | 60 | 187 | 298 |
| T30, ° C. | 64 | 231 | 302 | −0.4 | 201 | 299 | 60 | 208 | 300 |
| T40, ° C. | 80 | 248 | 303 | 27 | 217 | 301 | 64 | 230 | 302 |
| T50, ° C. | 92 | 261 | 304 | 36 | 234 | 302 | 69 | 248 | 304 |
| T60, ° C. | 98 | 270 | 306 | 60 | 249 | 303 | 90 | 264 | 305 |
| T70, ° C. | 113 | 277 | 309 | 68 | 262 | 304 | 92 | 274 | 308 |
| T80, ° C. | 126 | 281 | 315 | 90 | 271 | 306 | 93 | 281 | 314 |
| T90, ° C. | 138 | 284 | 331 | 105 | 278 | 311 | 105 | 285 | 330 |
| T95, ° C. | 146 | 285 | 371 | 116 | 280 | 319 | 113 | 286 | 368 |
| FBP, ° C. | 177 | 286 | 465 | 138 | 286 | 394 | 138 | 287 | 464 |
| T90 − | 111 | 84 | 33 | 118 | 101 | 15 | 77 | 116 | 34 |
| T10, ° C. | | | | | | | | | |

From table 7 it can be seen that the distillation characteristics of the gasoline, aviation, and diesel fuel components recovered from recycle effluents of the selected test runs comply with respective regulations.

Properties of the aviation fuel component from TR15, and from TR8 with optimised fractionation (TR8o), were analysed. Table 8 reports physico-chemical characteristics, and Table 9 reports composition details per carbon number as analysed by GCxGC-FID/GCxGC-MS. A paraffinic renewable jet fuel component obtained by conventional HDO of fatty feedstock and high severity HI process, i.e. without subjecting to hydrocracking, was used as a reference (RRJF).

TABLE 8
Physico-chemical characteristics of aviation fuel
components recovered from test runs TR15 and TR8o,
as compared to the reference jet component RRJF.

| | TR15 | TR8o | RRJF |
|---|---|---|---|
| Density at 15° C. (kg/m³), ENISO12185 | 768 | 766 | 772 |
| Flash point (° C.), IP 170-2013 (Abel closed- | 52 | 42 | 40 |
| cup method) | | | |
| Viscosity −20° C. (mm²/s), EN ISO 3104- | 6.7 | 7.8 | 11.4 |
| 2020 | | | |
| Viscosity −40° C. (mm²/s), EN ISO 3104- | 15.9 | 19.7 | 30.5 |
| 2020 | | | |
| Freezing point (° C.), ENISO 13736-2013/IP | −79.2 | Less | −49.6 |
| 529-2016 | | than −80 | |

TABLE 9
Compositional characteristics per carbon number, as determined by GCxGC-
FID/GCxGC-MS, of aviation fuel components recovered from test runs TR15
(total results) and TR8o (detailed results), compared to reference
jet component RRJF (total results). The results are given as wt-%.

| C | nP | mono-iP | iP-dime | iP-trime | iP-tetrame | Naphth | Arom | Total | Total | Total |
|---|---|---|---|---|---|---|---|---|---|---|
| no | TR8o | | | | | | | | TR15 | RRJF |
| 6 | 0.0 | 0.0 | 0.0 | 0.0 | 0.0 | 0.0 | 0 | 0.0 | 0.0 | 0.0 |
| 7 | 0.2 | 0.3 | 0.0 | 0.0 | 0.0 | 0.0 | 0 | 0.5 | 0.0 | 1.1 |
| 8 | 1.0 | 3.6 | 0.5 | 0.0 | 0.0 | 0.2 | 0 | 5.3 | 0.3 | 3.1 |
| 9 | 0.7 | 4.1 | 1.8 | 0.0 | 0.0 | 0.3 | 0 | 6.9 | 9.2 | 3.5 |
| 10 | 0.6 | 3.8 | 2.8 | 0.0 | 0.0 | 0.2 | 0 | 7.4 | 11.2 | 3.9 |
| 11 | 0.5 | 3.1 | 3.4 | 0.1 | 0.0 | 0.3 | 0 | 7.5 | 9.9 | 3.7 |
| 12 | 0.4 | 2.2 | 3.3 | 0.2 | 0.0 | 0.2 | 0 | 6.3 | 9.2 | 3.7 |
| 13 | 0.1 | 1.8 | 3.4 | 0.5 | 0.0 | 0.2 | 0 | 6.1 | 9.1 | 3.8 |
| 14 | 0.2 | 1.7 | 4.1 | 0.9 | 0.0 | 0.2 | 0 | 7.2 | 9.3 | 5.3 |
| 15 | 0.0 | 0.9 | 1.9 | 0.6 | 0.0 | 0.1 | 0 | 3.6 | 5.1 | 13.4 |
| 16 | 0.1 | 0.3 | 1.8 | 0.6 | 0.0 | 0.0 | 0 | 3.0 | 10.4 | 24.2 |
| 17 | 0.1 | 0.3 | 0.0 | 5.7 | 0.2 | 0.4 | 0 | 6.8 | 24.9 | 20.6 |
| 18 | 0.0 | 0.1 | 9.1 | 30.0 | 0.0 | 0.1 | 0 | 39.4 | 1.5 | 13.7 |
| 19 | 0.0 | 0.0 | 0.0 | 0.0 | 0.0 | 0.0 | 0 | 0.0 | 0.0 | 0.0 |
| Total | 4.1 | 22.2 | 32.2 | 38.7 | 0.2 | 2.3 | 0.3 | 100 | 100 | 100 |

In Table 9, nP refers to n-paraffins, mono-iP to mono-branched i-paraffins, iP-dime to i-paraffins having two (methyl) branches, iP-trime to i-paraffins having three (methyl) branches, and iP-tetrame to i-paraffins having four (methyl) branches.

From the aviation fuel component analyses (Tables 8) it can be seen that the aviation fuel components recovered from test runs had excellent cold properties, especially freezing point, and kinematic viscosity at −20° C. The compositional analysis reported in Table 9 reveals that for the aviation fuel components recovered from test runs, the wt-% amounts are more evenly distributed over the carbon numbers in the C6-C18 range: TR8o yielded 52.8 wt-%, and TR15 41.9 wt-% C15-C18 paraffins, compared to 71.9 wt-% of the reference RRJF. This contributes e.g. to a more balanced distillation curve and burning behaviour, as well as lower density. The detailed compositional analysis for the TR8o aviation fuel component reveals very low nP contents, and extremely high iP, and especially high multi-branched iP, contents, which is reflected in the excellent freezing points and sub-zero kinematic viscosities.

Characteristics of the diesel fuel components from TR8, TR8o, TR14, TR15, and TR16 were analysed and are reported in Table 10. A paraffinic renewable diesel fuel component of winter grade obtained by conventional HDO of fatty feedstock and medium severity HI process, i.e. without subjecting to hydrocracking, was used as a reference (Ref RDW). Fossil arctic diesel fuel component served as another reference, as well as Recycle Stream 2 (before hydrocracking).

TABLE 10
Physico-chemical characteristics of diesel fuel components recovered from test runs.

| | Cloud point, ° C. | Cetane number | Viscosity 40° C. | Density at | Calorific |
|---|---|---|---|---|---|
| | (ASTM D7689- | (ASTM D6890- | (mm²/s), EN | 15° C. (kg/m³), | value |
| Test Run | 17) | 16) | ISO 3104-2020 | ENISO12185 | (MJ/L) |
| TR8 | −43 | n.a. | 4.368 | 793 | 34.9* |
| TR8o | −46 | n.a. | n.a. | 793 | — |
| TR12 | −42 | n.a. | 4.320 | 792 | — |
| TR15 | −47 | 71.1 | 3.933 | 790 | — |
| TR16 | −35 | 82.5 | 3.939 | 788 | — |
| Recycle | −30 | 82.8 | 3.892 | 788 | — |
| stream 2 | | | | | |
| Ref RDW | −33 | 75.8 | 2.966 | 780 | 34.3* |
| Arctic | −42 | — | 1.731 | 818 | 35.2 |
| fossil | | | | | |
| diesel | | | | | |

*Assumed that calorific value for the TR8 diesel fuel component and Ref RDW was 44.0 MJ/kg.

From Table 10 it can be seen that the diesel fuel components recovered from test runs had improved cold properties in terms of cloud point, compared both to the reference renewable diesel of winter grade and Recycle Stream 2, while the measured cetane numbers were at a similar high level. Surprisingly, each of the diesel fuel components recovered from test runs had significantly higher viscosities at 40° C., and also higher densities, particularly compared to the reference winter diesel. This means that the diesel fuel components recovered from test runs may be incorporated in higher proportions to diesel fuels still meeting EN590-2022 Table 1 density at 15° C. requirement (820-845 kg/m³). The obtained diesel fuel components are also beneficial in arctic grade diesel fuels (EN 590-2022 Table 3), efficiently improving fuel's viscosity (at 40° C.) and spraying behaviour in the fuel system, leading to better fuel economy. Compositional analysis of the diesel fuel components recovered from test runs (results not reported) showed elevated total isoparaffin and multi-branched isoparaffin contents, compared to reference RDW, contributing to the excellent cloud point and viscosity characteristics seen in Table 10.

Characteristics of the gasoline fuel components from TR8, TR15, and TR8o were analysed and are reported in Table 11. A paraffinic renewable gasoline fuel component obtained by conventional HDO of fatty feedstock and medium severity HI process, i.e. without subjecting to hydrocracking, was used as a reference (Ref RG).

TABLE 11
Physico-chemical and compositional characteristics of
gasoline fuel components recovered from test runs.

| Gasoline fuel | | | Avg. | Avg. | |
|---|---|---|---|---|---|
| component | C4-C9 | C6-C8 iP/ | carbon | carbon | |
| from Test | iP, | C6-C8 nP, | number | number | bRON; |
| Run | wt-%* | wt-ratio* | C4-C9 iP* | C4-C9 nP* | bMON** |
| TR8 | 67.4 | 3.4 | 7.0 | 5.8 | n.a. |
| TR15 | 65.8 | 3.7 | 6.7 | 5.5 | n.a. |
| TR8o | 70.5 | 3.4 | 6.6 | 5.9 | 57.9; 56.3 |
| Ref RG | 49.2 | 1.4 | 6.9 | 6.3 | 46.8; 45.3 |

*Calculated based on wt-% amounts of n-paraffins, i-isoparaffins and multiple-branched i-paraffins of each carbon number as determined by GC-FID/GC-MS
**Blend RON (bRON) and blend MON (bMON) were determined according to ENISO5164-2014 (corresponding to ASTM D2699-18) and ENISO5163-2014 (corresponding to ASTM D2700-19), respectively, from blends with a commercial gasoline component having high i-paraffin content.

From Table 11 it can be seen that the determined bRON and bMON octane numbers were highly improved for gasoline fuel component recovered from test run compared to reference renewable gasoline fuel component (Ref RG). Additionally, each of the gasoline fuel components recovered from test runs had significantly higher contents of C4-C9 i-paraffins, compared to the reference renewable gasoline component. This suggests that the hydrocracking has not just cracked the paraffin molecules but also improved the isomerisation degree. The average carbon number in the C4-C9 range has decreased, especially for the n-paraffins. Both the higher isomerisation degree and the n-paraffins being shorter is believed to contribute to the improved octane numbers. Due to the improved properties, the gasoline fuel components can be blended into gasoline fuels in higher proportions than the reference renewable gasoline fuel component.

In summary, each of the liquid fuel components recovered from test runs had improved characteristics for use in fuel compositions, at least in terms of improved isomerisation degree, which generally enhances cold properties and fluidity/blendability even at lower temperatures. These and other of the improved characteristics of the liquid fuel components recovered from the test runs are desired and beneficial also in a wide range of other uses, particularly those involving spraying, injecting and/or admixing with other ingredients.

Various embodiments have been presented. It should be appreciated that in this document, words comprise, include, and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1-22. (canceled)

23. A process for producing at least one liquid transportation fuel component, the process comprising:
providing a paraffinic hydrocarbon feed including at least 60 wt-% paraffins of a total weight of the paraffinic hydrocarbon feed, wherein at most 30 wt-% of the paraffins are isoparaffins;
subjecting the paraffinic hydrocarbon feed in a first reactor to hydroisomerisation in a presence of a hydroisomerisation catalyst to obtain a hydroisomerisation effluent;
subjecting the hydroisomerisation effluent to fractionation to separate at least a recycle stream that includes C16 n-paraffins and has a T5 temperature (5 vol-% recovered, EN ISO 3405-2019) of 270° C. or higher;
subjecting a second reactor feed including the recycle stream to hydrocracking in a second reactor in a presence of a hydrocracking catalyst to obtain a recycle effluent;
feeding the recycle effluent to the fractionation as a co-feed with the hydroisomerisation effluent; and
recovering from the fractionation at least one or more liquid transportation fuel components.

24. The process according to claim 23, wherein the hydroisomerisation in the first reactor is conducted at a temperature within a range from 200° C. to 500° C., and/or from 230° C. to 500° C., and/or from 250° C. to 450° C., and/or from 280° C. to 400° C., a pressure within a range from 1 MPa to 10 MPa, and/or from 2 MPa to 8 MPa or from 3 MPa to 10 MPa, a H₂ partial pressure at an inlet of the first reactor within a range from 1 MPa to 10 MPa, and/or from 2 MPa to 8 MPa, a weight hourly space velocity within a range from 0.1 to 10, and/or from 0.2 to 8, and/or from 0.4 to 6 kg paraffinic hydrocarbon feed per kg catalyst per hour, and a H₂ to paraffinic hydrocarbon feed ratio within a range from 10 to 2000, and/or from 50 to 1000 normal liters H₂ per liter paraffinic hydrocarbon feed.

25. The process according to claim 23, wherein the hydrocracking in the second reactor is conducted at a temperature within a range from 200° C. to 450° C., and/or from 220° C. to 430° C., and/or from 280° C. to 350° C., a pressure within a range from 0.4 MPa to 8 MPa, and/or from 1 MPa to 7 MPa, and/or from 2.5 MPa to 7 MPa, a H₂ partial pressure at an inlet of the second reactor within a range from 0.4 MPa to 8 MPa, and/or from 1 MPa to 7 MPa, and/or from 2.5 MPa to 7 MPa, a weight hourly space velocity within a range from 0.1 to 10, and/or from 0.2 to 8, and/or from 0.4 to 6, and/or from 0.5 to 1.5 kg second reactor feed per kg catalyst per hour, and a H₂ to second reactor feed ratio within a range from 10 to 2000, and/or from 50 to 1000 normal liters H₂ per liter second reactor feed.

26. The process according to claim 23, wherein the first reactor is operated at a higher temperature than the second reactor.

27. The process according to claim 23, wherein the recycle stream comprises:
at least 50 wt-%, and/or at least 60 wt-%, and/or at least 70 wt-%, and/or at least 80 wt-% isoparaffins of a total weight of paraffins in the recycle stream; and/or at least 5 wt-%, and/or at least 10 wt-%, and/or at least 15 wt-%, and/or at least 20 wt-% multiple-branched isoparaffins of the total weight of paraffins in the recycle stream.

28. The process according to claim 23, wherein the recycle stream has a cloud point less than 0° C., and/or less than −5° C., and/or less than −8° C., and/or less than −10° C. (ASTM D 5771-17).

29. The process according to claim 23, wherein the recycle stream has a T5 temperature (ENISO3405-2019) within a range from 270° C. to less than 300° C., and/or within a range from 270° C. to less than 295° C., and/or within a range from 270° C. to less than 290° C., and/or an initial boiling point (IBP, ENISO3405-2019) less than 290° C., and/or less than 288° C., and/or less than 285° C., or less than 280° C.

30. The process according to claim 23, wherein the recycle effluent and the hydroisomerisation effluent are fed to the fractionation in a weight ratio from 1:10 to 10:1, or from 1:5 to 5:1.

31. The process according to claim 23, wherein the second reactor feed comprises:
a portion of the hydroisomerisation effluent.

32. The process according to claim 23, comprising:
monitoring to receive at least one or more values of at least one or more of the following parameters:
content of an impurity in the paraffinic hydrocarbon feed, and/or content of at least one or more of N, S, O, P, Si, Cl, Fe, alkali metals, alkaline earth metals, and/or coke-forming compounds in the paraffinic hydrocarbon feed;
content of NH₃ and/or H₂S in a gaseous phase of the hydroisomerisation effluent, and/or NH₃ and/or H₂S in a gaseous phase of the recycle effluent;
physico-chemical characteristics of the hydroisomerisation effluent and/or of the recycle effluent, and/or at least one or more of a cloud point, freezing point, pour point, cold filter plugging point, kinematic viscosity, density, and/or a distillation characteristic;
compositional characteristics of the hydroisomerisation effluent and/or of the recycle effluent, and/or at least one or more of content of isoparaffins, content of C8-C14 hydrocarbons, content of multiple-branched isoparaffins, and/or content of C1-C4 hydrocarbons in the hydroisomerisation effluent and/or the recycle effluent;
yield of at least one or more of the recovered liquid transportation fuel components and/or of the separated recycle stream, and/or yield of a recovered aviation fuel component;
physico-chemical characteristics of at least one or more of the recovered liquid transportation fuel components and/or the separated recycle stream, and/or at least one or more of a cloud point, freezing point, pour point, cold filter plugging point, kinematic viscosity, density, research octane number (RON), cetane number, and/or a distillation characteristic;
compositional characteristics of at least one or more of the recovered liquid transportation fuel components and/or the separated recycle stream, and/or content of isoparaffins and/or content of multiple-branched isoparaffins in the recovered fuel component(s) and/or in the separated recycle stream; and/or
temperature difference over the first reactor or over a catalyst bed therein, and/or over the second reactor or over a catalyst bed therein; and
comparing the received value(s) with predetermined value(s) and based on the comparison adjusting at least one or more operating conditions in the first reactor and/or in the second reactor, and/or adjusting at least one or more of temperature, pressure, weight hourly space velocity (WHSV), H₂ to paraffinic hydrocarbon feed ratio, H₂ to second reactor feed ratio, and/or H₂ partial pressure at an inlet of the first reactor and/or the second reactor, respectively, and/or increasing temperature and/or pressure in the first reactor and/or in the second reactor, and/or decreasing WHSV in the first reactor and/or in the second reactor, respectively.

33. The process according to claim 23, wherein the hydrocracking is followed by an additional hydroisomerisation in a presence of an additional hydroisomerisation catalyst, wherein each hydroisomerisation is conducted either at the same operating conditions, or operating conditions independently selected from one or more of the following:
a temperature within a range from 200° C. to 500° C., and/or from 230° C. to 500° C., and/or from 250° C. to 450° C., and/or from 280° C. to 400° C.,
a pressure within a range from 1 MPa to 10 MPa, and/or from 2 MPa to 8 MPa or from 3 MPa to 10 MPa,
a H₂ partial pressure at an inlet of an additional reactor or the first reactor within a range from 1 MPa to 10 MPa, and/or from 2 MPa to 8 MPa,
a weight hourly space velocity within a range from 0.1 to 10, and/or from 0.2 to 8, and/or from 0.4 to 6 kg paraffinic hydrocarbon feed or recycle effluent per kg catalyst per hour, and/or
a H₂ to paraffinic hydrocarbon feed or recycle effluent ratio within a range from 10 to 2000, and/or from 50 to 1000 normal liters H₂ per liter paraffinic hydrocarbon feed or recycle effluent.

34. The process according to claim 33, wherein the hydroisomerisation catalyst and/or the additional hydroisomerisation catalyst is/are bifunctional hydroisomerisation catalyst(s), and/or non-sulphided bifunctional hydroisomerisation catalyst(s), comprising:
at least one or more metals selected from Group VIII of the Periodic Table, and/or from noble metals of Group VIII, and/or from Pt and/or Pd; and
at least one or more acidic porous materials selected from zeolites and/or zeolite-type materials, and/or at least one or more of the zeolites and/or zeolite-type materials has a framework type selected from AEL, ATO, AFO, MRE, MTT, MTW, TON, MRT, MOR, FER, and/or MWW, and/or at least one or more acidic porous materials selected from SAPO-11, SAPO-31, SAPO-41, ZSM-22, ZSM-23, ZSM-48, NU-10, ZBM-30, IZM-2, EU-2, and/or mordenite, and/or at least one or more acidic porous materials selected from SAPO-11, SAPO-41, ZSM-23, and/or ZSM-48; and
optionally at least one or more of alumina, silica, amorphous silica-alumina, titanium alumina, titania, and/or zirconia.

35. The process according to claim 23, wherein the hydrocracking catalyst is a bifunctional hydrocracking catalyst, and/or a non-sulphided bifunctional hydrocracking catalyst, comprising:
at least one or more metals selected from Group VIII of the Periodic Table, Mo, Co, and/or W, and/or from Ni, Mo, Co, W, Pt and/or Pd, and/or from Pt and/or Pd; and
at least one or more acidic porous materials selected from zeolites, zeolite-type materials, and/or amorphous silica-alumina, and/or wherein at least one or more of the zeolites or zeolite-type materials has a framework type selected from MFI, BEA, FAU, MOR, FER, AEL, AFI, ATO, AFO, MRE, MTT, MTW, TON, and/or MRT, and/or at least one or more acidic porous materials selected from SAPO-5, SAPO-11, SAPO-31, SAPO-41, ZSM-22, ZSM-23, ZSM-43, ZSM-48, IZM-2, mordenite, beta-zeolites, Y-type zeolites, and/or amorphous silica-alumina and/or at least one or more acidic porous material selected from SAPO-5, SAPO-11, ZSM-23, beta-zeolites, Y-type zeolites, and/or amorphous silica-alumina; and
optionally at least one or more of alumina, silica, titanium alumina, titania, and/or zirconia.

36. The process according to claim 23, wherein the hydroisomerisation catalyst and the hydrocracking catalyst are different from each other.

37. The process according to claim 23, wherein the paraffinic hydrocarbon feed comprises:
at least 70 wt-%, and/or at least 80 wt-%, and/or at least 90 wt-%, and/or at least 95 wt-% paraffins of a total weight of the paraffinic hydrocarbon feed; and/or
at most 25 wt-%, and/or at most 20 wt-%, and/or at most 15 wt-% isoparaffins of the total weight of paraffins in the paraffinic hydrocarbon feed; and/or
at least 70 wt-%, and/or at least 80 wt-%, and/or at least 90 wt-%, and/or at least 95 wt-% C12-C30 hydrocarbons of the total weight of the paraffinic hydrocarbon feed; and/or
at least 70 wt-%, and/or at least 80 wt-%, and/or at least 90 wt-%, and/or at least 95 wt-% C14-C22 hydrocarbons of the total weight of the paraffinic hydrocarbon feed.

38. The process according to claim 23, wherein providing the paraffinic hydrocarbon feed comprises:
subjecting an oxygenated hydrocarbon feed to catalytic hydrodeoxygenation, to obtain a paraffinic hydrotreatment effluent, and
subjecting the paraffinic hydrotreatment effluent and/or the paraffinic FT effluent to gas-liquid separation and optionally to a paraffinic feed fractionation to provide the paraffinic hydrocarbon feed, or
subjecting a hydrotreatment feed to a catalytic hydrotreatment to obtain a paraffinic hydrotreatment effluent, wherein the hydrotreatment feed includes at least one or more of vegetable oil(s), animal fat(s), microbial oil(s), thermally liquefied organic waste and residue(s), and/or enzymatically liquefied organic waste and residue(s), and
subjecting the paraffinic hydrotreatment effluent to gas-liquid separation and optionally to a paraffinic feed fractionation to provide the paraffinic hydrocarbon feed.

39. The process according to claim 38, wherein providing the paraffinic hydrocarbon feed comprises:
subjecting an oxygenated hydrocarbon feed to catalytic hydrodeoxygenation, and wherein the hydrodeoxygenation is conducted in a presence of a hydrodeoxygenation catalyst, and at a temperature within a range from 200° C. to 500° C., a pressure within a range from 1 MPa to 20 MPa, a H₂ partial pressure at an inlet of the reactor within a range from 1 MPa to 20 MPa, a weight hourly space velocity within a range from 0.1 to 10 kg oxygenated hydrocarbon feed per kg catalyst per hour, and a H₂ to oxygenated hydrocarbon feed ratio within a range from 50 to 2000 normal liters H₂ per liter oxygenated hydrocarbon feed.

40. The process according to claim 38, wherein the hydrodeoxygenation catalyst is a sulphided catalyst comprising:
at least one or more metals from Group Vill of the Periodic Table and/or from Group VIB of the Periodic Table, and/or at least one or more of Ni, Mo, W, and/or Co, and/or at least one or more of Ni and/or Co and Mo and/or W, and/or NiMo, CoMo, NiCoMo, NiW, and/or NiMoW.

41. The process according to claim 23, wherein a biogenic carbon content (EN 16640 (2017)) of the paraffinic hydrocarbon feed is at least 50 wt-%, and/or at least 70 wt-%, and/or at least 90 wt-%, and/or at least 95 wt-%, or about 100 wt-%, based on a total weight of carbon (TC) in the paraffinic hydrocarbon feed.

42. The process according to claim 23, wherein
at least an aviation fuel component and optionally- a diesel fuel component are recovered from the fractionation; and/or
wherein at least one of the liquid transportation fuel components recovered from the fractionation is an aviation fuel component having density at 15° C. within a range from 730 to 772 kg/m³ (EN ISO 12185-1996), T10 temperature at most 205° C. (EN ISO 3405-2019), final boiling point at most 300° C. (EN ISO 3405-2019), flash point at least 38° C. (IP 170-2013, Abel closed-cup method), and freezing point at most −40° C. (IP 529-2016); and/or
recovering from the fractionation an aviation fuel component, in a yield of at least 30 wt-%, or at least 40 wt-% of a total weight of the paraffinic hydrocarbon feed.
